(19) United States
(12) Patent Application Publication
(10) Pub. No.: US 2025/0187620 A1
(43) Pub. Date: Jun. 12, 2025

(54) Artificial Intelligence/Machine Learning (AI/ML) Management of Vehicle Advanced Driver Assist System (ADAS) Drive Policies

(71) Applicant: QUALCOMM Incorporated, San Diego, CA (US)

(72) Inventors: Laxmi RAYAPUDI, San Diego, CA (US); Sanjay Kumar MADHAVARAO, San Diego, CA (US); Anshuman SAXENA, San Diego, CA (US)

(21) Appl. No.: 18/780,869

(22) Filed: Jul. 23, 2024

Related U.S. Application Data
(60) Provisional application No. 63/607,502, filed on Dec. 7, 2023.

(51) Int. Cl. B60W 50/10; G10L 15/22

(52) U.S. Cl. CPC B60W 50/10; G10L 15/22; B60W 2540/21; G10L 2015/223

(57) ABSTRACT

Various embodiments include methods and vehicles that may include managing driving policies in a vehicle advanced driver assist system (ADAS) that include obtaining vehicle sensor data, determining a current vehicle context based on the vehicle sensor data, selecting a modified vehicle driving policy from a plurality of saved modified vehicle driving policies based on the determined current vehicle context, and controlling vehicle behavior by the ADAS based upon the selected modified vehicle driving policy. Methods may also include receiving user voice inputs from a vehicle microphone, using a generative AI to infer relevance of the user voice inputs to vehicle driving policies or actions of the ADAS, adjusting a vehicle driving policy of the ADAS based on the inferred relevance of the user voice inputs, and commanding vehicle behavior based upon the adjusted vehicle driving policy.

### RELATED APPLICATIONS

This application claims the benefit of priority to U.S. Provisional Patent Application No. 63/607,502 entitled “Artificial Intelligence/Machine Learning (AI/ML) Management of Vehicle Advanced driver assist System (ADAS) Drive Policies” filed Dec. 7, 2023, the entire contents of which are incorporated herein by reference for all purposes.

### BACKGROUND

The advent of autonomous and semi-autonomous automobiles and other motor vehicles promises to ease the task of moving people, merchandise, and even the vehicles themselves from one place to another. For example, rather than having to maintain constant attention on the road and other vehicles, a vehicle operator may allow an autonomous or semi-autonomous vehicle to control all or most of the driving operations of the vehicle. Also, a fully autonomous vehicle, which does not require a driver, may operate without passengers.

For vehicles that control operation of the operation of the vehicle, the control operations mainly involve a computerized vehicle management system that uses a set of vehicle policies that control the operation of the vehicle based upon detected conditions about the vehicle. However, such sets of vehicle policies do not take advantage of vehicle context data when determining a policy used to control the vehicle.

### SUMMARY

Various aspects include methods and vehicles implementing in such methods that provide Artificial Intelligence (AI) and/or Machine Learning (ML) Advanced Driver Assist System (ADAS) drive policy management for various operating modes to take advantage of improvements in operating efficiency, selecting operating policies to be used, etc. by detecting current vehicle context based upon preferences of a driver and/or passenger present in the vehicle.

Various aspects may include methods of enabling a user to influence vehicle driving policy decisions of a vehicle ADAS based on user voice inputs, which may include receiving user voice inputs from a vehicle microphone, using a generative AI to infer relevance of the user voice inputs to vehicle driving policies or actions of the ADAS, adjusting a vehicle driving policy of the ADAS based on the inferred relevance of the user voice inputs; and commanding vehicle behavior based upon the adjusted vehicle driving policy.

Some aspects may further include selecting one of a plurality of saved modified vehicle driving policies based on the inferred relevance of the user voice inputs, and setting the vehicle driving policy of the ADAS to the selected one of the plurality of saved vehicle driving policies. Some aspects may further include recognizing, based on the inferred relevance of the user voice input, that the user has provided a hint related to driving behaviors of the vehicle, and modifying the vehicle driving policy of the ADAS in response to recognizing that the user has provided a hint related to driving behaviors of the vehicle.

Some aspects may further include recognizing based on the inferred relevance of the user voice input that the user has provided a hint related to a condition external to the vehicle, and reevaluating data of vehicle external sensors used by the ADAS in making driving decisions in response to recognizing that the user has provided a hint related to a condition external to the vehicle. Some aspects may further include recognizing based on the inferred relevance of the user voice input that the user has issued a command related to a driving behavior of the vehicle, and implementing the user's command in response to the recognized that the user has issued a command related to driving behavior of the vehicle.

Further aspects may include methods of managing driving policies in a vehicle ADAS based on vehicle context and user voice inputs, which may include obtaining vehicle sensor data, determining a vehicle context based on the vehicle sensor data, receiving user voice inputs from a vehicle microphone, using a generative AI to infer relevance of the user voice inputs to vehicle driving policies or actions of the ADAS, selecting a modified vehicle driving policy from a plurality of saved modified vehicle driving policies based upon the determined vehicle context and the inferred relevance of the user voice inputs to vehicle driving policies or actions of the ADAS; and controlling vehicle behavior based upon the selected modified vehicle driving policy.

Further aspects include a vehicle including a processing system configured to perform operations of any of the methods summarized above. Further aspects include an exterior shape modification device configured for use in a vehicle and to perform operations of any of the methods summarized above. Further aspects include an AI/ML ADAS drive policy management system configured for use in a vehicle and to perform operations of any of the methods summarized above. Further aspects include a vehicle having means for performing functions of any of the methods summarized above. Further aspects include a non-transitory processor-readable media having stored thereon processor-executable instructions configured to cause a processing system of a vehicle to perform operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 are schematic diagrams illustrating a vehicle within a system suitable for implementing various embodiments.

FIG. 2 is a schematic diagram illustrating a vehicle and vehicle systems suitable for implementing various embodiments.

FIGS. 3A-3C are schematic block diagrams illustrating components of an example vehicle management system according to some embodiments.

FIG. 4 is a schematic block diagram illustrating components of an AI/ML ADAS drive policy management system according to some embodiments.

FIG. 5A is a schematic block diagram illustrating components of an example system on chip for use in a vehicle in accordance with various embodiments.

FIG. 5B is a processing module block diagram of a vehicle processing system and functional modules in accordance with various embodiments.

FIG. 5C is an illustrative block diagram of an example machine learning (ML) model represented by an artificial neural network (ANN) suitable for implementing various embodiments.

FIG. 6 is a vehicle highway diagram of an example use of an AI/ML ADAS drive policy management system according to some embodiments.

FIGS. 7A and 7B are a vehicle driving policy selection operations example of an AI/ML ADAS drive policy management system according to some embodiments.

FIGS. 8A and 8B are other examples of vehicle driving policy selection operations of an AI/ML ADAS drive policy management system according to some embodiments.

FIGS. 9A-9C are process flow diagrams of an example method of an AI/ML ADAS drive policy management system according to some embodiments.

FIGS. 10A-10E are process flow diagrams of an example method of an AI/ML ADAS drive policy management system according to some embodiments.

FIG. 11 is a process flow diagram of an example method of an AI/ML ADAS drive policy management system according to some embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include vehicles and methods of operating such vehicles that provide an Artificial Intelligence (AI) and/or Machine Learning (ML) (abbreviated AI/ML herein) Advanced Driver Assist System (ADAS) management system configured to select or adjust vehicle driving/operating policies for the vehicle by detecting current vehicle context and selecting/adjusting the policies based upon preferences of a driver and/or passenger present in the vehicle. In some embodiments, a vehicle processing system may detect the current vehicle context based upon preferences of a driver and/or passenger present in the vehicle. For example, in some embodiments, the vehicle processing system may receive user (e.g., the driver and/or passengers) voice inputs by interpreting words spoken by such person or persons using generative AI systems, and adjust the vehicle's driving policy of the ADAS based on AI inferences drawn from the vocal inputs. As another example, the vehicle processing system may detect and determine the identity of the driver and any passengers in the vehicle. Using the determined identity of the driver and/or passengers, the vehicle processing system may determine operating mode preferences of the driver and/or passengers that may be used to select vehicle driving policies to control the operation of the vehicle consistent with these operating mode preferences.

In some embodiments, the vehicle processing system may determine that a particular vehicle context should be utilized to select a set of vehicle policies to be used to control the operation of the vehicle in response in anticipation of an upcoming change in operating mode by receiving instructions from an operator and/or a vehicle system, such as a navigation system, a route planning system, a scheduling system, etc. In some embodiments, the vehicle processing system may determine whether to select a set of vehicle policies based on a detected vehicle context in response to a planned or predicted future operating mode, event, or environment.

When no passengers are present in a vehicle along with the driver, the driver's preferred set of driving policies may be utilized to control the operation of the vehicle. Similarly, when there are one or more passengers present in the vehicle, a preferred set of driving policies may differ among the occupants of the vehicle. Based on the identity of the driver and passengers, the vehicle processing system may determine an appropriate vehicle driving policy for the ADAS to implement.

Additionally, various electronic and mechanical components of the vehicle may be disabled or changed to take advantage of the fact that the vehicle has no occupants (e.g., in a passenger-less operating mode) or that no occupant has elected to drive (e.g., in a driverless operating mode).

In various embodiments, the modification to the configuration of the vehicle to a driven configuration, a driverless mode and/or a passenger-less mode may occur at almost any time if warranted. For example, the modification to the driving configuration, the driverless mode, and/or the passenger-less mode may be performed while the vehicle is stationary (i.e., at a stop or parked) or while moving (i.e., in motion on or off road).

The word “exemplary” is used herein to mean “serving as an example, instance, or illustration.” Any implementation described herein as “exemplary” is not necessarily to be construed as preferred or advantageous over other implementations.

As used herein, the terms “wireless network,” “cellular network,” and “cellular wireless communication network” are used interchangeably herein to refer to a portion or all of a wireless network of a carrier associated with a wireless device and/or subscription on a wireless device.

As used herein, the term “system on chip” (SOC) is used herein to refer to a processing system implemented on a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

As used herein, the term “system in a package” (SIP) may be used herein to refer to a processing system implemented on a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high-speed communication circuitry and packaged in close proximity, such as on a single motherboard or in a single wireless device. The proximity of the SOCs facilitates high-speed communications and the sharing of memory and resources.

As used herein, the term “multicore processor” may be used herein to refer to a single integrated circuit (IC) chip or chip package that contains two or more independent processing cores (e.g., CPU core, Internet protocol (IP) core, graphics processor unit (GPU) core, etc.) configured to read and execute program instructions. A SOC may include multiple multicore processors, and each processor in a SOC may be referred to as a core. The term “multiprocessor” may be used herein to refer to a system or device that includes two or more processing units configured to read and execute program instructions.

As used herein, the term “processing system” is used herein to refer to one more processor, including multi-core processors, that are organized and configured to perform various computing functions. Various embodiment methods may be implemented in one or more of multiple processors within any of a variety of vehicle computers and processing systems as described herein.

As used herein, the expression “vehicle context” refers to a recognized set of vehicle conditions used to select a set of vehicle driving policies consistent with the set of vehicle conditions at a particular point in time. Other optional implementations are possible and contemplated within the scope of various claims.

As used herein, the expression “set of vehicle driving policies” refers to a collection of vehicle behavior rules to be applied to current vehicle conditions to control vehicle behavior at any particular point in time. The vehicle behavior rules may control the vehicle speed, steering, braking, and related control functions of the vehicle when in motion.

As used herein, the expressions “driver-less configuration” and “driver-less mode” refer to a vehicle configuration in which passengers occupy the vehicle, but no one is driving (i.e., the vehicle is operating autonomously). In the driverless configuration, there should be room for at least one passenger to occupy the vehicle.

As used herein, the expression “passenger-less mode” refers to a vehicle context in which there are no passengers in addition to the driver inside the vehicle, and thus no need to consider vehicle policy preferences of any occupant of the vehicle other than the driver. In accordance with some embodiments, there may be more than one of each of the set of vehicle operating policies for each identified driver and/or passenger.

In accordance with some embodiments, the determination of vehicle context and the selection of a set of vehicle driving policies to be used to control the vehicle may also be based on auditory voice inputs (e.g., spoken words) captured by a vehicle microphone from the driver and/or passengers. The vehicle processing system may infer driver and/or passenger driving policy preferences using the captured auditory voice inputs.

As used herein, the expression “a planned or predicted future operating mode, event or environment” refers to something that is anticipated or planned to happen or conditions that are anticipated or predicted to occur at a later time, and may be based on schedules, navigation planning, sensor detections, observations, and/or deduction, particularly something of significance to a vehicle.

Various embodiments may be implemented, at least in part, using an artificial intelligence (AI) model or processing system, such as a software program executing in a vehicle processing system that includes a trained machine learning (ML) or artificial neural network (ANN) model. An example ML model may include mathematical representations or define computing capabilities for making inferences from input data based on patterns or relationships in the input data that are recognized after suitable training. As used herein, the term “inferences” refers to one or more of decisions, predictions, determinations, or values, which may be provided as outputs of the ML model. The elements of an ML model that are trained may be defined in terms of certain parameters of the ML model, such as weights and biases. Weights may be adjusted and set through a learning process that reflects relationships between certain input data and certain outputs in the training data set used to train the ML model. Biases are offsets which may indicate a starting point for outputs of the ML model, which also may be adjusted and set during training. An example ML model operating on input data may start at an initial output based on the biases and then update its output based on a combination of the input data and the weights.

ML models may be characterized in terms of types of learning that generate specific types of trained ANN models that perform specific types of tasks. For example, different types of machine learning include supervised learning, unsupervised learning, semi-supervised learning, reinforcement learning, etc. ML models may be used to perform different tasks, such as classification or regression. Classification refers to determining one or more discrete output values from a set of predefined output values. Regression refers to determining continuous values that are not bounded by predefined output values. A classification ML model configured according to various embodiments may produce an output that identifies a particular modification of ADAS driving policies that should be selected based on context and/or input sensor data. A regression ML model configured according to embodiments of this disclosure may produce an output that responds to driver and/or passenger actions and/or speech to influence ADAS operations, such as double checking sensor data or considering suggestions (or hints) in ADAS decision-making without changing ADAS driving policies.

Some ML models configured for performing such tasks may include ANNs, such as convolutional neural networks (CNN) and recurrent neural networks (RNN), transformers, diffusion models, regression analysis models (such as statistical models), large language models (LLM), decision tree learning (such as predictive models), support vector networks (SVM), and probabilistic graphical models (such as a Bayesian network), etc. For ease of description, various types of ML models that may be used to implement various embodiments are referred to herein generally as an “AI/ML model,” which should be understood to include any of ANN models, CNN models, RNN models, LLMs, decision tree learning (such as predictive models), support vector networks (SVM), and probabilistic graphical models (such as a Bayesian network), and the like.

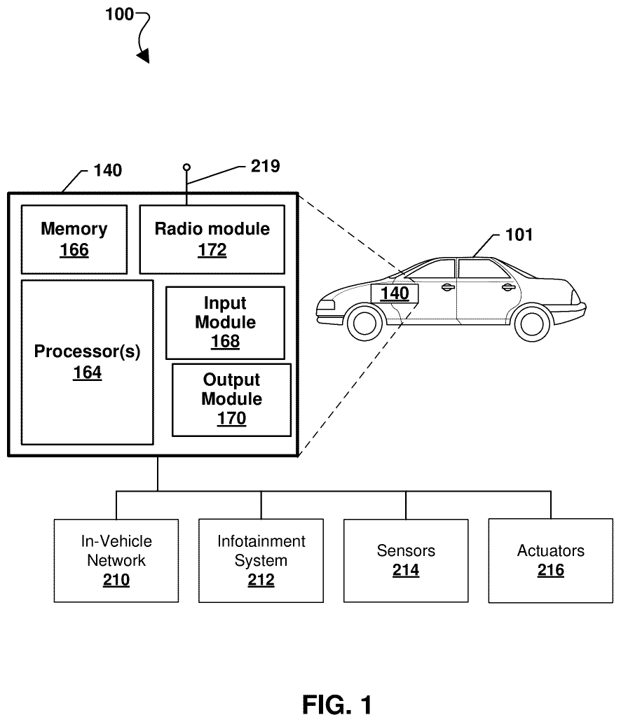

FIG. 1 are schematic diagram 100 illustrating a vehicle 101 within a system suitable for implementing various embodiments. The vehicle 101 may be capable of both autonomous and semiautonomous navigation. A vehicle control unit 140 may operate using one or more components, including an in-vehicle network 210, an infotainment system 212, one or more sensors 214, and one or more actuators 216. The vehicle control unit 140 may obtain data from the one or more components 210-216 to provide commands to control the vehicle behavior when operating in an autonomous and semiautonomous navigation mode.

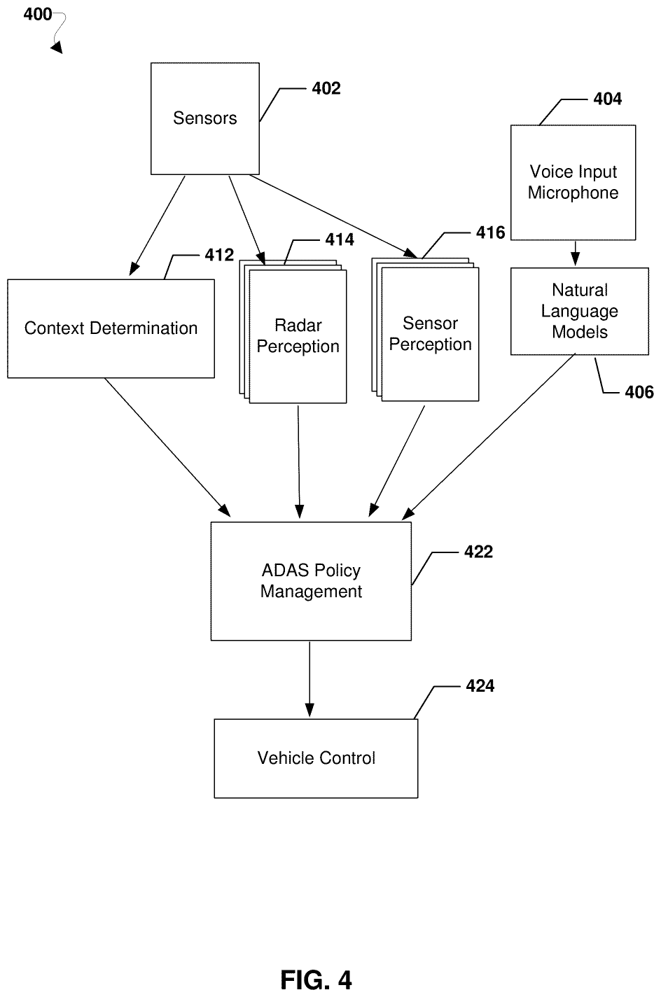

The vehicle control unit 140 utilizes one or more sets of vehicle driving policies to generate the commands to control the vehicle behavior utilizing an AI/ML ADAS drive policy management system 400 as described with reference to FIG. 4. The AI/ML ADAS drive policy management system 400 utilizes sensor data and other information to determine a vehicle context, such as the identity of a driver and the presence of passengers within the vehicle 101 at any given time. The vehicle context may be used to select a set of vehicle driving policies from a plurality of sets of vehicle driving policies. For example, a first set of vehicle driving policies may exist for a vehicle context in which the driver is alone in the vehicle 101. A second set of vehicle driving policies also may exist for when the driver is traveling with a child in the back seat of the vehicle 101. The second set of vehicle driving policies may command the vehicle 101 to operate at a slower speed and choose to pass other vehicles on the roadway less aggressively when compared to when the driver is alone. The vehicle context may be based upon all available information accessible by the vehicle control unit 140.

The vehicle control unit 140 may determine a current vehicle context which is provided to the AI/ML ADAS drive policy management system 400 to select one of the one or more sets of vehicle driving policies for use when generating commands to control the vehicle behavior. Each set of vehicle driving policies may include preferences of one or more individuals regarding the vehicle behavior in a particular situation. These preferences may be based upon pre-defined parameters entered into the vehicle control unit 140 and/or may be based upon inferences made by an artificial intelligence and/or machine learning engine (referred to generally herein as AI/ML) that has been trained to process data received from vehicle sensors during operation of the vehicle 101 and output an inference regarding selecting and/or adjusting various operating conditions or driving policies of the ADAS.

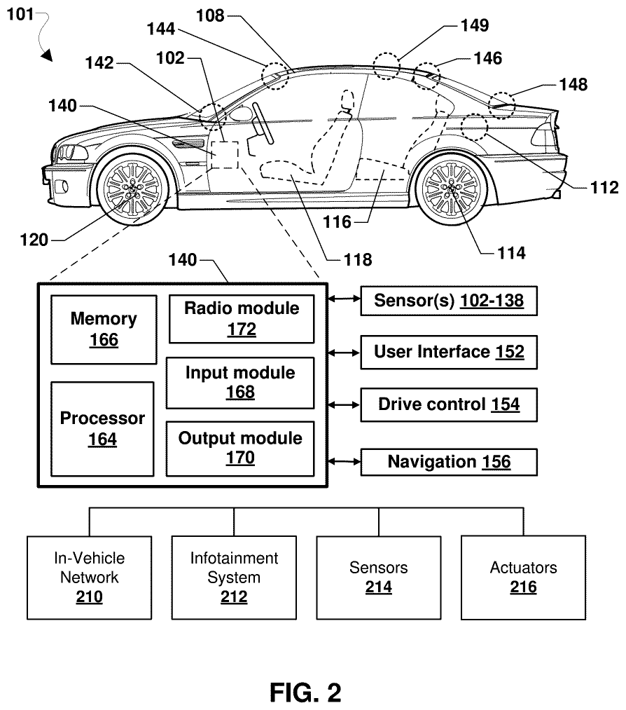

Various embodiments may be implemented within a variety of vehicles equipped with an AI/ML ADAS drive policy management system 400, an example of which is illustrated in FIG. 2. With reference to FIGS. 1-2, a vehicle 101 may include a plurality of sensors 102-138 disposed in or on the vehicle that are used for various purposes involved in autonomous and semiautonomous navigation as well as sensor data regarding objects and people in or on the vehicle 101. The sensors 102-138 may include one or more of a wide variety of sensors capable of detecting a variety of information useful for navigation, collision avoidance, and vehicle occupancy. Each of the sensors 102-138 may be in wired or wireless communication with a control unit 140, as well as with each other. In particular, the sensors may include one or more cameras 122, 136 or other optical sensors or photo optic sensors. The sensors may further include other types of object detection and ranging sensors, such as radar 132, lidar 138, infrared (IR) sensors, and/or ultrasonic sensors. The sensors may further include tire pressure sensors 114, 120, humidity sensors, temperature sensors, satellite geo-positioning sensors 108, accelerometers, vibration sensors, gyroscopes, gravimeters, impact sensors 130, force meters, stress meters, strain sensors, fluid sensors, chemical sensors, gas content analyzers, pH sensors, radiation sensors, Geiger counters, neutron detectors, biological material sensors, microphones 124, 134, occupancy sensors 112, 116, 118, 126, 128, door sensors 115, 117, proximity sensors, and/or other sensors.

In various embodiments, the actuators 216 may be used to change a shape, length, and/or orientation of various interior parts of the vehicle, including (but not limited to) seats, steering wheels, pedals, armrests, visual aids (e.g., rearview mirror or external camera), controls and other interior equipment. For example, actuators coupled to or included within the seats may be configured to rotate seats in one detected vehicle context and/or cause seats to fold or flatten in an alternate vehicle context to increase interior volume and accommodate changes in the external shape of the vehicle.

In various embodiments, the actuators 216 may be any device or element configured to move, change, and/or operate another device or element of the vehicle 101. The actuators 216 may include or work to activate smart materials configured to change shape. For example, smart materials may be configured to change from having a smooth outer surface to having a dimpled outer surface (e.g., like a golf ball), which may improve or alter vehicle aerodynamics. The smart materials may be activated by electrical or other stimuli configured to cause the smart materials to change shape in a controlled manner (e.g., from a flat/smooth surface to a surface having a series of dimples on the exterior thereof). For example, the use of smart materials to create dimpling on exterior surfaces of the vehicle may be implemented on any surface that is exposed to airflow while moving, such as on the windshield, on the hood, roof, and trunk, on side panels, on side windows, exterior rearview mirrors (if deployed), moonroof, etc.

The vehicle control unit 140 may include a processing system 164 that is configured with processor-executable instructions to perform various embodiments using information received from various inputs, including a user interface 152, radio module 172, and/or sensors 102-138, including the cameras 122, 136, microphones 124, 134, door sensors 115, 117, and occupancy sensors 112, 116, 118, 126, 128. The control unit 140 or its processing system 164 may be configured to receive occupancy information from the sensors 102-138, which the control unit or its processing system may use to determine the occupancy status of the vehicle 101. In addition, the control unit 140 or its processing system may be communicatively coupled to the actuators 216 and configured to activate the actuators 216 to change an exterior shape or interior configuration of the vehicle 101 when appropriate. For example, the control unit 140 may change a detected vehicle context based upon some external stimulus or condition, such as electricity, light, temperature, pH, stress, moisture, etc. The control unit 140 or its processing system 164 may further be configured to control the steering, breaking, and speed of the vehicle 101 consistent with either a passenger-less or normal operating mode using information regarding other vehicles determined using various embodiments. The control unit 140 or its processing system 164 may be communicatively coupled to the actuators 216 through wired (e.g., electrical and/or optical) and/or wireless connections. The communicative coupling may be through one or more intermediate connectors (e.g., a bus) or a direct coupling.

The control unit 140 processing system 164 may be configured with processor-executable instructions to control shape changing, maneuvering, navigation, and other operations of the vehicle 101, including operations of various embodiments. The processing system 164 may be coupled to a memory 166. The control unit 140 may include an input module 168, an output module 170, and a radio module 172 that may each be coupled to the processing system 164.

The radio module 172 may be coupled to an antenna 219 and configured for wireless communication. The radio module 172 may exchange signals (e.g., command signals for controlling shape changes, maneuvering, signals from navigation facilities, etc.) with a network transceiver, and may provide the signals to the processing system 164 and/or the navigation components 156. The signals may be used by the radio module 172 to receive shape change commands and/or input. In some embodiments, the radio module 172 may enable the vehicle 101 to communicate with a wireless communication device through a wireless communication link. The wireless communication link may be a bidirectional or unidirectional communication link and may use one or more communication protocols.

The input module 168 may receive configuration change inputs from the user interface 152 or the radio module 172. In addition, the input module 168 may receive sensor data from one or more vehicle sensors as well as electronic signals from other components, including the user interface 152, the drive control components 154, and the navigation components 156. In some embodiments, the input module 168 may be configured to determine when a driver and/or passengers are not present in the vehicle and generate the configuration change input based on such determinations. In some embodiments, the input module 168 may be configured to receive information from navigation components 156 and other components (e.g., a scheduling unit) and determine when a change in configuration is anticipated (e.g., changing to the passenger mode upon arriving at a destination to pick up a passenger or changing to a passenger-less mode upon arriving at a destination to pick up cargo) so that the configuration change can be started in time to be completed by the time that the new configuration is appropriate.

The output module 170 may be used to communicate with or activate various components of the vehicle 101, including the drive control components 154, the navigation components 156, and the sensor(s) 158.

The control unit 140 or its processing system 164 may be coupled to and configured to control various drive control components 154, navigation components 156, and one or more vehicle sensors 102-138 of the vehicle 101. The drive control components 154 may be used to control physical elements of the vehicle 101 that affect maneuvering and navigation of the vehicle, such as the engine, motors, throttles, steering elements, flight control elements, braking or deceleration elements, and the like. The drive control components 154 may also include components that control other devices of the vehicle, including environmental controls (e.g., air conditioning and heating), external and/or interior lighting, interior and/or exterior informational displays (which may include a display screen or other devices to display information), and other similar devices.

While the control unit 140 is described as including separate components, in some embodiments, some or all of the components (e.g., the processing system 164, the memory 166, the input module 168, the output module 170, and the radio module 172) may be integrated in a single processing system device or module, such as a system-on-chip (SOC) processing device. Such an SOC processing device may be configured for use in vehicles and be configured, such as with processor-executable instructions executing in the processing system 164, to perform operations of various embodiments when installed into a vehicle.

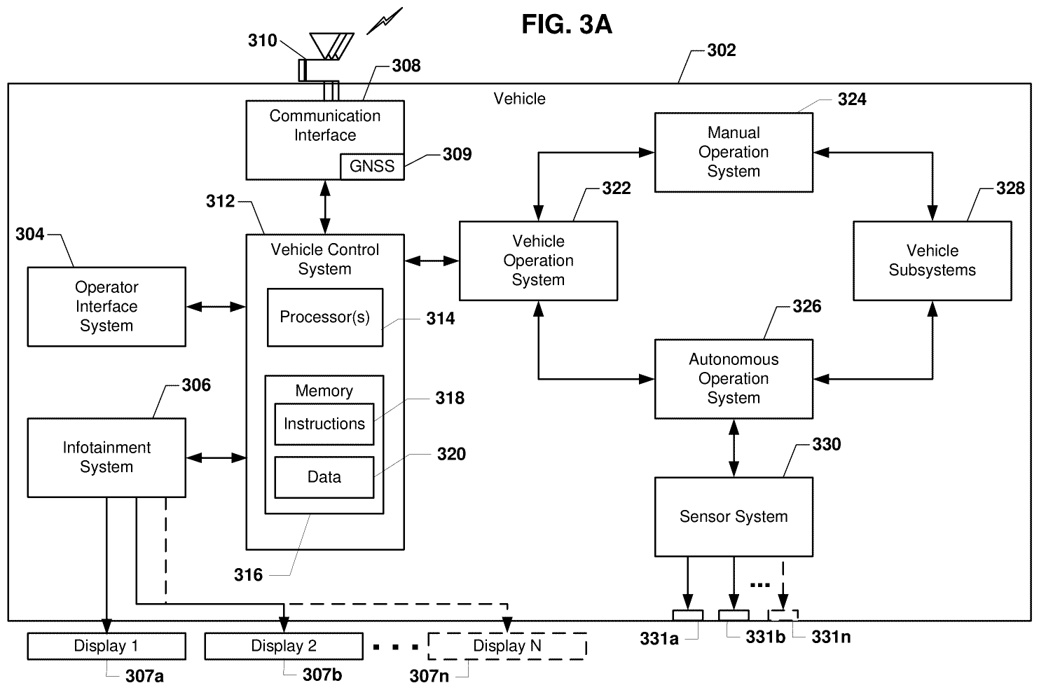

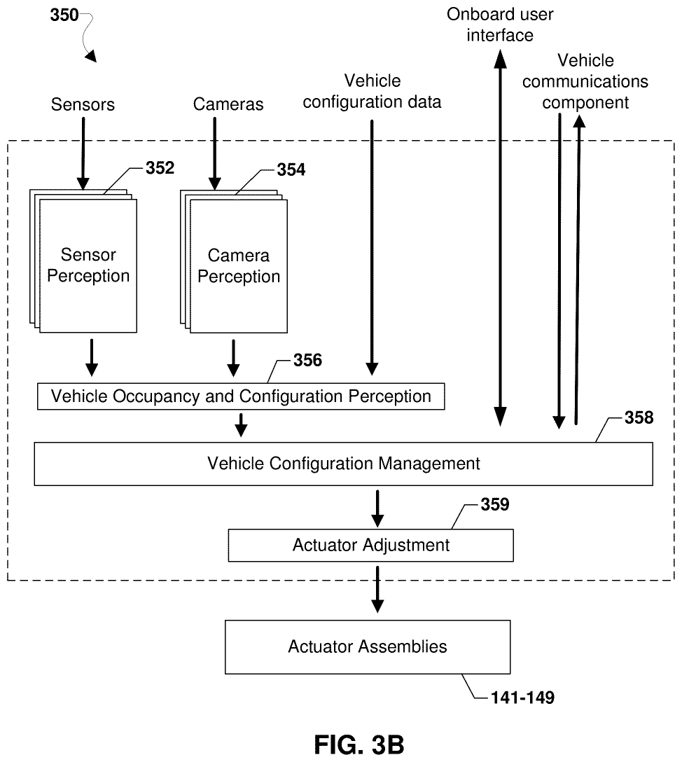

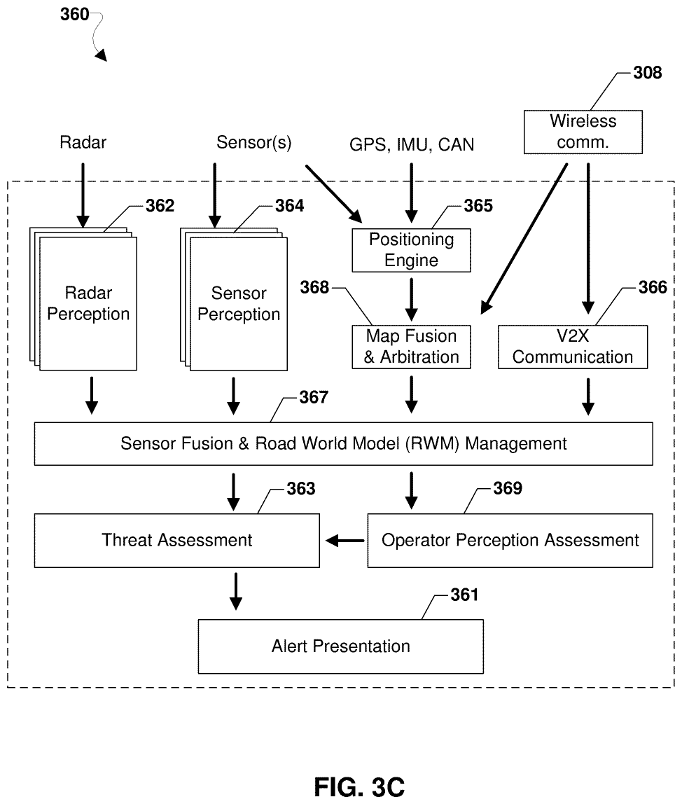

FIGS. 3A-3C are schematic block diagrams illustrating components of an example vehicle management system according to some embodiments. Various embodiments may be implemented within a variety of vehicles capable of autonomous operation, an example of which may be suitable for use with various embodiments is illustrated in FIG. 3A. With reference to FIGS. 1-3A, a vehicle 302 capable of autonomous operation may include an operator interface system 304, an infotainment system 306, a communication interface 308, a vehicle control system 312, a vehicle operation system 322, a manual operation system 324, an autonomous operation system 326, vehicle subsystems 328, and a sensor system 330. In some embodiments, the vehicle 302 may be vehicle 101. The communication interface 308 may include a receiver for a global navigation satellite system (GNSS) 309.

The operator interface system 304 may be configured to receive inputs from and/or provide output communications to an operator of the vehicle 302. The operator interface system 304 may include input elements such as keys, buttons, a touchscreen, a microphone, a camera, etc. and/or output elements such as a display, speakers, etc. to allow the operator of the vehicle 302 to interact with various systems of the vehicle 302 during operation of the vehicle 302.

The infotainment system 306 may be configured to display infotainment information to transition the gaze of the operator such that the operator's attention or awareness may be guided to an environment external to the vehicle 302. In some embodiments, the infotainment system 306 may be coupled to a plurality of displays. For example, as illustrated in FIG. 3A, the infotainment system 306 may be coupled to a first display 307a and a second display 307b. In addition, the infotainment system 306 may optionally be coupled to any number of displays, including display N 307n.

The communication interface 308 may be configured to communicate with one or more other elements, sensors, communication network nodes, vehicles, or other entities, either directly or via a communication network. The communication interface 308 may be configured to wirelessly communicate using one or more radio access technologies or protocols using one or more antennas 310 and one or more modems corresponding to the one or more antennas (not illustrated). For example, the communication interface 308 may be configured to communicate using Bluetooth, IEEE 802.11, near field communications (NFC), cellular technology such as SGM, CDMA, UMTS, EV-DO, WiMAX, and LTE, ZigBee, dedicated short range communications (DSRC), radio frequency identification (RFID) communications, and any revisions or enhancements of any of the above communication technologies as well as any future wireless communication technologies.

In addition, the communication interface 308 may further include a Global Navigation Satellite System (GNSS). The GNSS may be a satellite-based location or global coordinate determining system for determining the coordinates of the vehicle 302 within a global coordinate system. In addition, the GNSS may include a global positioning system (GPS). In some embodiments, the GNSS may include a transceiver configured to estimate the location of the vehicle 302 on the Earth based on satellite-based positioning data. The vehicle control system 312 may be configured to use the information received by the GNSS in combination with map data stored in memory 316 (e.g., data 320) to estimate a location of the vehicle 302 with respect to a road on which the vehicle 302 is traveling.

The vehicle control system 312 may be configured to control the operation of the vehicle 302. The vehicle control system 312 may include one or more processors 314, one or more memory elements 316, instructions 318, and data 320. The one or more processors 314 may include a general-purpose processor and/or a special purpose processor configured to execute the instructions 318 stored in the memory 316. In some embodiments, the one or more processors 314 may use at least a portion of the data 320 stored in the memory 316 during the execution of the instructions 318. The one or more processors 314 may also contain on-board memory (not shown) and may comprise distributed computing functionality. In some embodiments, the vehicle control system 312 may be configured to receive information from and/or control various systems and subsystems of the vehicle 302.

The vehicle operation system 322 may be configured to switch the vehicle between autonomous operation and manual operation. In some embodiments, based on parameters monitored using the sensor system 330 and/or inputs provides at the operation interface system 304, the vehicle control system 312 may instruct the vehicle operation system 322 to control the switching between autonomous operation and manual operation of the vehicle 302. While the vehicle control system 312 is illustrated in FIG. 3A as a separate module, the functions or operations of the vehicle control system 312 may be incorporated into the vehicle control system 312, the manual operation system 324, and/or the autonomous operation system 326.

The manual operation system 324 may be configured to control the vehicle 302 to operate in a manual mode. For example, the manual operation system 324 may control the vehicle based on one or more manual inputs provided by an operator. The one or more manual inputs may be received from the operator via various vehicle subsystem input elements such as a gas pedal, a brake pedal, a steering wheel, etc.

The autonomous operation system 326 may be configured to control the vehicle 302 to operate in an autonomous mode. For example, the autonomous operation system 326 may control the vehicle based on one or more parameters measured using the sensor system 330 without direct operator interaction.

The sensor system 330 may be configured to detect or sense information about an external environment associated with the vehicle 302 and/or information associated with one or more of the vehicle subsystems 328. The sensor system 330 may include a plurality of sensors 331a, 331b, 331n. In addition, the sensor system 330 may further include one or more actuators associated with the plurality of sensors 331a, 331b, 331n such that the actuators may be configured to change or modify a position and/or orientation of one or more of the plurality of sensors 331a, 331b, 331n.

In some embodiments, the sensors of the sensor system 330 that are configured to detect information about the external environment may include one or more of a camera, a microphone, an ultrasonic sensor, a radio detection and ranging (RADAR) sensor, and a light detection and ranging (LiDAR) sensor. The sensors of the sensor system 330 that are configured to detect information associated with one or more of the vehicle subsystems 302 may include one or more of a wheel sensor, a speed sensor, a break sensor, a gradient sensor, a weight sensor, a heading sensor, a yaw sensor, a gyroscope sensor, a position sensor, an accelerometer, an autonomous operation forward/reverse sensor, a battery sensor, a fuel sensor, a tire sensor, one or more steering sensors (e.g., sensors associated with the steering wheel and sensors associated with the steering column), an interior temperature sensor, an exterior temperature sensor, an interior humidity sensor, an exterior humidity sensor, an illuminance sensor, a collision sensor, and the like. In addition, the sensor system 330 may further include sensors associated with accessory subsystems such as heating or air conditioning subsystems, window control subsystems, airbag control systems, etc.

The vehicle subsystems 328 may include any subsystems used in operating vehicle 302 (e.g., manual and autonomous operation). For example, the vehicle subsystems 328 may include one or more of an engine or motor, an energy source, a transmission, wheels/tires, a steering system, a braking system, a computer vision system, an obstacle avoidance system, a throttle, etc.

In some embodiments, the engine may include one or more of internal combustion elements, electric motor elements, steam engine elements, gas-electric hybrid elements, or a combination thereof. The energy source may include one or more of fuels (e.g., gasoline, diesel, propane, ethanol, etc.), batteries, solar panels, etc., or a combination thereof. The transmission may include one or more of a gearbox, a clutch, a differential, a drive shaft, an axle, etc. The steering system may include one or more of a steering wheel, a steering column, etc. The braking system may be configured to slow the speed of the vehicle using friction. The computer vision system may be configured to process and analyze images captured by one or more cameras in order to identify objects and/or features of the external environment associated with the vehicle 302. In some embodiments, the computer vision system may use computer vision techniques to map the external environment, track objects, estimate speed of objects, identify objects, etc. The obstacle avoidance system may be configured to identify, evaluate, and avoid or otherwise negotiate obstacles in the external environment of the vehicle 302. The throttle may be configured to control the operating speed and acceleration of the engine and thus the speed and acceleration of the vehicle 302.

FIG. 3B illustrates an example of subsystems, computational elements, computing devices or units within a vehicle management system 350, which may be utilized within a vehicle 101 implementing various embodiments. With reference to FIGS. 1A-3B, in some embodiments, the various computational elements, computing devices or units within vehicle management system 350 may be implemented within a system of interconnected computing devices (i.e., subsystems), that communicate data and commands to each other (e.g., indicated by the arrows in FIG. 3B). In other embodiments, the various computational elements, computing devices or units within vehicle management system 350 may be implemented within a single computing device, such as separate threads, processes, algorithms or computational elements. Therefore, each subsystem/computational element (e.g., illustrated in FIG. 3B) is also generally referred to herein as a “layer” within a computational “stack” that constitutes the vehicle management system 350. However, the use of the terms layer and stack in describing various embodiments are not intended to imply or require that the corresponding functionality is implemented within a single autonomous (or semi-autonomous) vehicle control system computing device, although that is a potential implementation embodiment. Rather, the use of the term “layer” is intended to encompass subsystems with independent processors, computational elements (e.g., threads, algorithms, subroutines, etc.) running in one or more computing devices, and combinations of subsystems and computational elements.

In various embodiments, the vehicle management system 350 may include a sensor perception layer 352, a camera perception layer 354, a vehicle occupancy and configuration perception layer 356, a vehicle configuration management layer 240, and an actuator adjustment layer 359. The layers 352-359 are merely examples of some layers in one example configuration of the vehicle management system 350 and in other configurations other layers may be included, such as additional layers for other perception sensors (e.g., vehicle load sensors, etc.) or safety and non-occupancy confirmation, and/or certain of the layers 352-359 may be excluded from the vehicle management system 200. Each of the layers 352-359 may exchange data, computational results and commands (e.g., as illustrated by the arrows in FIG. 3B).

The vehicle management system 350 may be configured to receive and process data from sensors (e.g., pressure, motion, inertial measurement units (IMU), etc.), cameras, vehicle databases/memory (e.g., storing vehicle configuration data), an onboard user interface, and vehicle communications component(s) (e.g., one or more wireless transceivers). The vehicle management system 350 may output actuator adjustment commands or signals to one or more actuator assemblies (e.g., 216), which are systems, subsystems, or computing devices that interface directly with exterior and interior vehicle parts/components configured to change shape/position when commanded to do so.

The sensor perception layer 352 may receive data from one or more sensors (e.g., occupancy sensors 102-138) and process the data to recognize and determine whether any occupants are currently in the vehicle, and if so, where they are seated and whether they are driving the vehicle 101. Non-limiting examples of sensors that may be used as occupancy sensors 102-138 include weight/force sensors in the vehicle seats, sensors that may detect the presence of mobile computing devices within the vehicle (e.g., connecting through Bluetooth, WiFi, vehicle hotspot, etc.), mechanical devices (e.g., a vehicle button, handle, pedal, and/or knob that may be manipulated and provides an indication that a person occupies the vehicle), and/or voice recognition systems (e.g., an occupant verbally indicating presence). In addition, the sensor perception layer 352 may receive data from one or more other sensors configured to detect a current position/configuration of vehicle parts and process the data to recognize and/or confirm the current position/configuration of one or more vehicle parts. The sensor perception layer 352 may use neural network processing and artificial intelligence methods to recognize occupants, objects, and/or the position/configuration of vehicle parts. In addition, the sensor perception layer 352 may be configured to pass any vehicle occupancy data and/or current vehicle parts configuration data along to the vehicle occupancy and configuration perception layer 356.

The camera perception layer 354 may receive data from one or more cameras (e.g., 122, 136) and process the data to recognize and determine whether any occupants are currently in the vehicle and, if so, where they are seated and whether they are driving the vehicle 101. In addition, the camera perception layer 354 may receive data from one or more cameras configured to detect a current position/configuration of vehicle parts, and process the data to recognize and/or confirm the current position/configuration of one or more vehicle parts. The camera perception layer 354 may use neural network processing and artificial intelligence methods to recognize occupants, objects, and/or the position/configuration of vehicle parts. In addition, the camera perception layer 354 may be configured to pass any vehicle occupancy data and/or current vehicle parts configuration data along to the vehicle occupancy and configuration perception layer 356.

The vehicle occupancy and configuration perception layer 356 may receive and/or access vehicle occupancy inputs from the sensor perception layer 352 and the camera perception layer 354 for determining the occupancy status of the vehicle. The vehicle occupancy and configuration perception layer 356 may compare and use any redundant vehicle occupancy input received from the sensor perception layer 352 and/or the camera perception layer 354 to ensure any determined vehicle occupancy status is accurate. The vehicle occupancy and configuration perception layer 356 may be configured to feed any determined vehicle occupancy data to the vehicle configuration management layer 358.

In addition, the vehicle occupancy and configuration perception layer 356 may also receive and/or access vehicle parts configuration inputs from the sensor perception layer 352 and the camera perception layer 354 for determining the current parts configuration of the vehicle. The vehicle occupancy and configuration perception layer 356 may receive and/or access stored vehicle configuration data from one or more vehicle databases/memory that store information about the configuration and position of vehicle parts. The vehicle occupancy and configuration perception layer 356 may also compare the stored vehicle configuration data with other processed data from the sensor perception layer 352 and the camera perception layer 354 to determine/confirm a true current position and/or orientation of vehicle parts. The vehicle occupancy and configuration perception layer 356 may also be configured to feed the determined current vehicle parts configuration data to the vehicle configuration management layer 358.

The vehicle configuration management layer 358 may access or automatically receive vehicle information, including any determined vehicle occupancy status and/or vehicle parts configuration data, from the vehicle occupancy and configuration perception layer 356. In addition, the vehicle configuration management layer 358 may receive a configuration change input from an onboard user interface. For example, the vehicle's dashboard may include the onboard user interface, which may have one or more buttons or a touch screen display configured to receive occupant commands for initiating the modification of the vehicle's shape. Also, the vehicle configuration management layer 358 may receive a vehicle occupancy input from a vehicle communications component (e.g., radio module 172), wired connection, or other electronic connection to an occupant's onboard mobile device (e.g., cell phone, smart watch, tablet, computer, etc.) or other computing device remote from the vehicle.

In response to receiving a change in data from, cameras, vehicle databases/memory, an onboard user interface, and vehicle communications component(s), the vehicle configuration management layer 358 may determine whether a current vehicle context determination needs to change consistent with an operating mode (e.g., driverless mode, passenger-less mode, cargo mode, passenger mode, etc.). This determination may be made, at least in part, based on the received vehicle occupancy status and the received vehicle parts configuration data. The determination as to whether the vehicle context should be changed may take into account the determined vehicle occupancy data and the determined current vehicle parts configuration data received from the vehicle occupancy and configuration perception layer 356, as well as one or more vehicle inputs from the onboard user interface and/or the vehicle communications component. If the vehicle context does not need to change, the vehicle configuration management layer 358 need not signal the actuator adjustment layer 359 to activate actuator assemblies 216. If the vehicle context is to be changed, the vehicle configuration management layer 358 may signal the AI/ML ADAS drive policy management system (e.g., 400 FIG. 4) to determine whether the set of vehicle driving policies currently in use needs to be changed.

In an example scenario, the vehicle configuration management layer 358 may receive a configuration change input from an onboard user interface or a vehicle communications component. The received configuration change input may represent instructions to change vehicle operating mode from one configuration (e.g., the driven configuration) to another configuration (e.g., the driverless configuration). For example, the vehicle may be occupied by a driver and one or more passengers, but the driver has decided to allow the vehicle to operate autonomously and has activated an application (e.g., from a device, such as mobile communication device or the like) that sent a configuration change input directing the vehicle to change the vehicle operating mode and active set of vehicle driving policies accordingly.

In another scenario, the sensor perception layer 352 may receive data indicating that the vehicle is unoccupied and being operated autonomously. Accordingly, the vehicle configuration management layer 258 may transition to the passenger-less mode by activating select actuators configured to change the configuration of interior components and/or the exterior shape of a body of the vehicle to a no-occupant configuration. Transitioning to the passenger-less mode may also involve making changes to the vehicle configuration management layer 358 (or in a separate layer not shown) to the navigation and control parameters for operating the vehicle autonomously, such as changing maximum or minimum operating speeds, adjusting turn rate limits, adjusting breaking rates, adjusting minimum vehicle separation distances, accessing roadways limited to passenger-less vehicle travel, etc.

Alternatively, configurations (i.e., modes) may be limited to use with particular other configurations. For example, various configurations may be based upon the identity of vehicle occupants, such as the identity of the driver and the identities of any passengers in the vehicle. Other configurations may be available as well, such as non-autonomous, semi-autonomous, driverless, sleeping/resting occupant(s), facing occupants, or vehicle charging configurations.

In various embodiments, the vehicle management system 350 may include functionality that performs safety checks or oversight of various commands, planning, or other decisions of various layers that could impact vehicle and occupant safety. Such safety checks or oversight functionality may be implemented within a dedicated layer (not shown) or distributed among various layers and included as part of the functionality. In some embodiments, a variety of safety parameters may be stored in memory, and the safety checks or oversight functionality may compare a determined value (e.g., size and/or weights of occupants) to corresponding safety parameter(s), and issue a warning or command if the safety parameter is or will be violated. For example, a safety or oversight function in the vehicle configuration management layer 358 (or in a separate layer not shown) may determine whether it is safe to change a shape of the vehicle based on other factors, such as when the vehicle is moving or when another object or vehicle nearby is too close for the vehicle shape to expand.

Some safety parameters stored in memory may be static (i.e., unchanging over time), such as maximum/minimum vehicle height. Other safety parameters stored in memory (e.g., headroom) may be dynamic in that the parameters are determined or updated continuously or periodically based on the vehicle occupants.

FIG. 3C is a component block diagram illustrating components of an example vehicle sensor, sensor processing, and ADAS system 360 that may be implemented in a vehicle in some embodiments. The vehicle sensor, sensor processing, and ADAS system 360 may include various subsystems, communication elements, computational elements, computing devices or units that may be utilized within a vehicle 101. With reference to FIGS. 1-3C, the various computational elements, computing devices or units within the vehicle sensor, sensor processing, and ADAS system 360 may be implemented within a system of interconnected computing devices (i.e., subsystems) that communicate data and commands to each other (e.g., indicated by the arrows in FIG. 3C). In some implementations, the various computational elements, computing devices or units within vehicle alert management system 360 may be implemented within a single computing device, such as separate threads, processes, algorithms, or computational elements. Therefore, each subsystem/computational element illustrated in FIG. 3C is also generally referred to herein as a “layer” within a computational “stack” that constitutes the vehicle sensor, sensor processing, and ADAS system 360. Again, the use of the terms layer and stack in describing various embodiments are not intended to imply or require that the corresponding functionality is implemented within a single autonomous (or semi-autonomous) vehicle management system computing device, although that is a potential implementation embodiment. Rather, the use of the term “layer” is intended to encompass subsystems with independent processors, computational elements (e.g., threads, algorithms, subroutines, etc.) running in one or more computing devices, and combinations of subsystems and computational elements.

The vehicle sensor, sensor processing, and ADAS system 360 may include a radar perception layer 362, a sensor perception layer 364, a positioning engine layer 365, a map fusion and arbitration layer 368, a V2X communications layer 366, sensor fusion and road world model (RWM) management layer 368, threat assessment layer 363, operator perception assessment layer 369, and the ADAS decision layer 361. The layers 361-369 are merely examples of some layers in one example configuration of the vehicle sensor, sensor processing, and ADAS system 360. In other configurations, other layers may be included, such as additional layers for other perception sensors (e.g., LIDAR perception layer, etc.), additional layers for generating alerts and/or alert modality selection, additional layers for modeling, etc., and/or certain of the layers 361-369 may be excluded from the vehicle sensor, sensor processing and ADAS system 360. Each of the layers 361-369 may exchange data, computational results and commands as illustrated by the arrows in FIG. 3C. Further, the vehicle sensor, sensor processing, and ADAS system 360 may receive and process data from sensors (e.g., radar, lidar, cameras, inertial measurement units (IMU), etc.), navigation systems (e.g., Global Position System (GPS) receivers, IMUs, etc.), vehicle networks (e.g., Controller Area Network (CAN) bus), and databases in memory (e.g., digital map data). The vehicle sensor, sensor processing and ADAS system 360 may output alerts and/or commands for generating alerts on a select in-vehicle alert modality. The configuration of the vehicle sensor, sensor processing, and ADAS system 360 illustrated in FIG. 3C is merely an example configuration, and other configurations of a vehicle management system and other vehicle components may be used. As an example, the configuration of the vehicle sensor, sensor processing, and ADAS system 360 illustrated in FIG. 3C may be used in a vehicle configured for autonomous or semi-autonomous operation while a different configuration may be used in a non-autonomous vehicle.

The radar perception layer 362 may receive data from one or more detection and ranging sensors, such as radar (e.g., 132) and/or lidar (e.g., 138), and process the data to recognize and determine locations of other vehicles and objects within a vicinity of the vehicle 101. The radar perception layer 362 may include the use of neural network processing and artificial intelligence methods to recognize objects and vehicles and pass such information on to the sensor fusion and RWM management layer 367.

The sensor perception layer 364 may receive data from one or more sensors, such as cameras (e.g., 122, 136) and other sensors (e.g., 102-138), and process the data to recognize and determine locations of other vehicles and objects within a vicinity of the vehicle 101, as well as observations regarding the driver (e.g., a direction of the operator's gaze). The sensor perception layer 364 may include the use of neural network processing and artificial intelligence methods to recognize objects and vehicles and pass such information on to the sensor fusion and RWM management layer 367.

The positioning engine layer 365 may receive data from various sensors and process the data to determine the location of the vehicle 101. The various sensors may include, but are not limited to, a GPS sensor, an IMU, and/or other sensors connected via a CAN bus. The positioning engine layer 365 may also utilize inputs from one or more sensors, such as cameras (e.g., 122, 136) and/or any other available sensor, such as radars, LIDARs, etc.

The vehicle sensor, sensor processing, and ADAS system 360 may include or be coupled to a vehicle wireless communication subsystem 308. The wireless communication subsystem 308 may be configured to communicate with other vehicle computing devices and remote V2X communication systems 366, such as via V2X communications.

The map fusion and arbitration layer 368 may access sensor data received from other V2X system participants and receive output received from the positioning engine layer 365 and process the data to further determine the position of the vehicle 101 within the map, such as location within a lane of traffic, position within a street map, etc. sensor data may be stored in a memory (e.g., memory 166). For example, the map fusion and arbitration layer 368 may convert latitude and longitude information from GPS into locations within a surface map of roads contained in the sensor data. GPS position fixes include errors, so the map fusion and arbitration layer 368 may function to determine a best guess location of the vehicle within a roadway based upon an arbitration between the GPS coordinates and the sensor data. For example, while GPS coordinates may place the vehicle near the middle of a two-lane road in the sensor data, the map fusion and arbitration layer 368 may determine from the direction of travel that the vehicle is most likely aligned with the travel lane consistent with the direction of travel. The map fusion and arbitration layer 368 may pass map-based location information to the sensor fusion and RWM management layer 367.

The V2X communication layer 366 may receive and utilize sensor data and other inputs from an intelligent transportation system (ITS) to collect information about moving objects and conditions near and around the vehicle (e.g., 101) that may aid the ADAS in making driving decisions and select suitable driving policies based on external conditions (e.g., roadway construction, traffic conditions, accidents, etc.). The V2X communications received by the V2X communication layer 366 may provide many types of information. For example, other vehicles or roadside units may provide camera images or sensor readings that may be analyzed (i.e., measuring proximity, motion, trajectory, etc.). The V2X communication layer 366 may pass V2X messaging information to the sensor fusion and RWM management layer 367. However, the use of V2X messaging information by other layers, such as the sensor fusion and RWM management layer 367, etc., is not required. For example, other stacks may control the vehicle (e.g., controlling one or more vehicle displays) without using received V2X messaging information.

The sensor fusion and RWM management layer 367 may receive data and outputs produced by the radar perception layer 362, sensor perception layer 364, map fusion and arbitration layer 368, and V2X communication layer 366, and use some or all of such inputs to estimate or refine the location and state of the vehicle 101 in relation to the road, other vehicles on the road, and other objects or creatures within a vicinity of the vehicle 101.

For example, the sensor fusion and RWM management layer 367 may combine imagery data from the sensor perception layer 364 with arbitrated map location information from the map fusion and arbitration layer 368 to refine the determined position of the vehicle within a lane of traffic. As another example, the sensor fusion and RWM management layer 367 may combine object recognition and imagery data from the sensor perception layer 346 with object detection and ranging data from the radar perception layer 362 to determine and refine the relative position of other vehicles and objects in the vicinity of the vehicle. As another example, the sensor fusion and RWM management layer 367 may receive information from V2X communications (such as via the CAN bus or wireless communication subsystem 366) regarding other vehicle positions and directions of travel and combine that information with information from the radar perception layer 362 and the sensor perception layer 364 to refine the locations and motions of other objects.

The sensor fusion and RWM management layer 367 may compile for output situational information that provides details regarding the location and surroundings of the vehicle and its surroundings. Situational information may include refined location and state information of the vehicle 101, as well as refined location and state information of other vehicles and objects in the vicinity of the vehicle. Thus, the sensor fusion and RWM management layer 367 may output the situational information to the threat assessment layer 363 and/or the operator perception assessment layer 369.

As a further example, the sensor fusion and RWM management layer 367 may monitor perception data from various sensors, such as perception data from a radar perception layer 362, sensor perception layer 364, other perception layers, etc., and/or data from one or more sensors themselves to analyze conditions in the vehicle sensor data. The sensor fusion and RWM management layer 367 may be configured to detect conditions in the sensor data, such as sensor measurements being at, above, or below a threshold, certain types of sensor measurements occurring, etc., and may output the sensor data as part of the refined location and state information of the vehicle 101 provided to the operator perception assessment layer 369 and/or devices remote from the vehicle 101, such as a data server, other vehicles, etc., via wireless communications, such as through V2X connections, other wireless connections, etc.

The refined location and state information may include vehicle descriptors associated with the vehicle and the vehicle owner and/or operator, such as: vehicle specifications (e.g., size, weight, color, on board sensor types, etc.); vehicle position, speed, acceleration, direction of travel, attitude, orientation, destination, fuel/power level(s), and other state information; vehicle emergency status (e.g., is the vehicle an emergency vehicle or private individual in an emergency); vehicle restrictions (e.g., heavy/wide load, turning restrictions, high occupancy vehicle (HOV) authorization, etc.); capabilities (e.g., all-wheel drive, four-wheel drive, snow tires, chains, connection types supported, on board sensor operating statuses, on board sensor resolution levels, etc.) of the vehicle; equipment problems (e.g., low tire pressure, weak brakes, sensor outages, etc.); owner/operator travel preferences (e.g., preferred lane, roads, routes, and/or destinations, preference to avoid tolls or highways, preference for the fastest route, etc.); permissions to provide sensor data to a data agency server (e.g., network server 184); and/or owner/operator identification information.

The operator perception assessment layer 369 of the vehicle sensor, sensor processing and ADAS system 360 may use the situational information output from the sensor fusion and RWM management layer 367 to predict future behaviors of other vehicles and/or objects. For example, the operator perception assessment layer 367 may use such situational information to predict future relative positions of other vehicles in the vicinity of the vehicle based on own vehicle position and velocity and other vehicle positions and velocity. Such predictions may consider information from the local dynamic map data and route planning to anticipate changes in relative vehicle positions as the host and other vehicles follow the roadway. The operator perception assessment layer 369 may output other vehicle and object behavior and location predictions to the threat assessment layer 363. Additionally, the operator perception assessment layer 369 may use object behavior in combination with location predictions to plan and generate control signals for controlling the motion of the vehicle 101. For example, based on route planning information, refined location in the roadway information, and relative locations and motions of other vehicles, the operator perception assessment layer 369 may determine that the vehicle 101 needs to change lanes and accelerate/decelerate, such as to maintain or achieve minimum spacing from other vehicles, and/or prepare for a turn or exit. As a result, the operator perception assessment layer 369 may calculate or otherwise determine a steering angle for the wheels and a change to the throttle setting to be commanded to the threat assessment layer 363 and vehicle control unit 140 along with such various parameters necessary to effectuate such a lane change and acceleration and/or determine whether they were handled safely by the driver.

The threat assessment layer 363 may receive situational information, such as the data and information outputs from the sensor fusion and RWM management layer 367 and other vehicle and object behavior, as well as location predictions from the operator perception assessment layer 369 and use this information to determine whether the driver needs to be alerted. In addition, in response to determining that the driver needs to be alerted, the threat assessment layer 363 may receive driver state information from the sensor perception layer 364, via the sensor fusion and RWM management layer 368, as well as from the operator perception assessment layer 369. The threat assessment layer 363 may use the driver state information to determine an appropriate alert for the driver, as well as the one or more alert modalities that should be used for presenting the alert to the driver.

The threat assessment layer 363 may select one or more alert modalities based on a determined likelihood the driver will be more receptive to the chosen one or more alert modalities than other ones or combinations of the plurality of alert modalities. The likelihood of the driver being most receptive to the selected one or more alert modalities may be determined based on the received situational information, the received driver state information, and a historical behavior record of the driver. The historical behavior record of the driver may correlate the driver's reaction to a previous alert presented using one of the plurality of alert modalities with similar driver state information and similar situational information triggering the presentation of the previous alert.

Additionally, the determination of the likelihood that the driver will be receptive to the alert modality may be further based on feedback from reactions of other drivers in other vehicles to previously presented alerts under similar circumstances. For example, similar circumstances may include a close enough match of previous situational information that resembles the subject situational information without being identical. As a further example, similar circumstances may include a close enough match of previous other-driver state information that resembles the subject driver state information without being identical. The feedback from reactions of other drivers may be compiled by one or more computers (e.g., cloud-based storage), such as a remote server, a fleet operator control system, any one or more vehicle computers, or other computing device(s). The threat assessment layer 363 may receive the feedback from reactions of other drivers through the wireless communications via the V2X communication layer 366 and the Sensor Fusion & RWM Management layer 367. In this way, feedback information about other driver reactions to one or more alert modalities under similar circumstances may be used to determine the likelihood that the subject driver will be receptive to the alert modality.

The threat assessment layer 363 may use the behavior of the driver to determine the driver's attention level, which may be divided into classes. Each class of behavior may have its own unique alert structure or set of preferred alert modalities. The driver's most recent behavior is preferably used, meaning the behavior within, for example, the latest 5-minute timeframe, since the driver's attention may fluctuate over time. The threat assessment layer 363 may be more accurate if it exclusively uses the most recent situational and driver state information. For example, receiving a call on a cell phone while driving is a common example of a reason a driver may shift their attention while driving. In this example, if the threat assessment layer 363 did not use the most recent and up-to-date data, the threat assessment layer 363 might classify the driver's engagement level as more attentive than they are at that moment, which might negatively impact response time or situational awareness.

With the attention levels defined within the system, the threat assessment layer 363 may classify how attentive the driver is based on eye gaze, facial expressions, head orientation, posture, vocalizations, sounds, movement, interaction with a mobile phone or other peripheral computing device, performance in handling the vehicle (e.g., reaction time), as well as other conditions reflecting what is happening inside the vehicle. That classification level may then correspond to the system using the best alert structure for that driver (i.e., the appropriate alert for the selected one or more alert modalities). This level of customization may be safer than the current one-size-fits-all approach to alerting drivers.

The threat assessment layer 363 may determine a customized alert and select one or more alert modalities for each driver based on their personal preferences, driving scenario, internal factors, external factors, and severity of the situation. Internal and external factors may refer to activities happening in the vehicle's cabin and conditions happening on the road outside of the vehicle, respectively. In determining the customized alert and selecting the one or more alert modalities to use for presenting the customized alert, the threat assessment layer 363 may use a historical behavior record of the driver, which correlates the driver's reaction to a previous alert presented using one of the plurality of alert modalities with similar driver state information and similar situational information triggering the presentation of the previous alert.

The assessment as to whether situational information or driver state information entries of the historical behavior record or the feedback information about other driver reactions are “similar” to that of current situational information or driver state information, respectively, received by the vehicle computing device may be performed using one or more of various approaches. One way to determine whether conditions are similar is to compare the data that is being collected in the current situation with data collected in a previous situation. This could involve comparing numerical values, text, or other types of data. Another approach is to use machine learning algorithms to analyze the data and determine whether the conditions are similar. These algorithms can be trained on data from previous situations and can use various techniques, such as clustering or classification, to identify patterns and determine whether the current conditions are similar to those in a previous situation. In some cases, computers can use rules or heuristics to determine whether conditions are similar. For example, if a computer is trying to identify whether two situations are similar, it might use a rule that states that if two situations have the same characteristics, they are similar.

Characteristics of the driver, which may be measured by the sensor perception layer 364, may gather data such as head position, facial expression, and response time. This information may be used for the system to continuously learn what the driver's preferences are. Details in the facial expression, such as raising eyebrows, frowning, and changes in eye gaze, can indicate that the user did not respond well to a particular alert and its alert modalities. This may then prompt the system to determine if the alert or the alert modalities may be altered to better suit the driver. Perhaps the driver was dissatisfied with how much information was provided or the alert modality that was used. The next alert and selected one or more alert modalities may be modified to get closer to the driver's “optimal” alert structure until it is eventually determined. The learning algorithm could potentially learn directly from the driver by surveying the driver once the vehicle is parked and the journey has been completed, or even during manual driving.

Driving scenarios may also impact the determination by the threat assessment layer 363 to alert the driver and which alert modalities to use. For example, the driver could be driving in a lane that is ending; this would require the driver to merge into a neighboring lane. There are many ways that the vehicle sensor, sensor processing and ADAS system 360 may communicate the situation, risks, and desired driver feedback to the driver. In addition, there are many ways the driver may react to the sudden ending of the lane in which his/her vehicle is traveling. The scenario may prompt the user to feel nervous or anxious, the driver could brake harshly, or he/she could react nonchalantly. If the driver begins experiencing negative feelings or performing hazardous driving actions, then the system could adapt future alerts to improve the safety and experience of the driver. The driver's reaction to an alert may become associated with a particular scenario so that the threat assessment layer 363 knows how to mitigate problems in similar driving scenarios in the future.

Beyond what is happening outside of the vehicle, there may be scenarios of events happening inside the vehicle that can affect the performance of the driver. A common example of this is driving with noisy kids, pets, or music in the vehicle. In scenarios like this, the driver could miss an audible alert; however, the driver may have been more receptive to a visual/haptic combination. Therefore, conditions like cabin volume may be used by the threat assessment layer 363 to determine the most effective alert modality or combination of alert modalities to alert the driver.

In various embodiments, the wireless communication subsystem 308 may communicate with other V2X system participants via wireless communication links to transmit sensor data, position data, vehicle data, and data gathered about the environment around the vehicle by onboard sensors. Such information may be used by other V2X system participants to update stored sensor data for relay to other V2X system participants.

In various embodiments, the vehicle sensor, sensor processing, and ADAS system 360 may include functionality that performs safety checks or oversight of various commands, planning, or other decisions of various layers that could impact vehicle and occupant safety. Such safety check or oversight functionality may be implemented within a dedicated layer or distributed among various layers and included as part of the functionality. In some embodiments, a variety of safety parameters may be stored in memory, and the safety checks or oversight functionality may compare a determined value (e.g., relative spacing to a nearby vehicle, distance from the roadway centerline, etc.) to the corresponding safety parameter(s), and issue a warning or command if the safety parameter(s) is/are or will be violated. For example, a safety or oversight function in the operator perception assessment layer 369 (or in a separate layer) may determine the current or future separation distance between another vehicle (as defined by the sensor fusion and RWM management layer 367) and the vehicle (e.g., based on the world model refined by the sensor fusion and RWM management layer 367), compare that separation distance to a safe separation distance parameter stored in memory, and pass along such information to the threat assessment layer 363.

In some embodiments, the operator perception assessment layer 369 may monitor and assess a driver's engagement level with regard to the operation of the vehicle before, during, and after the presentation of an alert. The driver's engagement level may include the driver's emotional state (e.g., as perceived from outward appearance and/or biometric data) and/or reaction to a presented alert using a select one or more alert modalities. For example, camera images or video may be analyzed to detect the driver's reaction to an alert using a particular alert modality. Facial expressions, posture, and/or body movements may be used to characterize a driver's emotional state (e.g., smiling/laughing equals happy, frowning equals upset) to determine a driver's emotional state. Similarly, a microphone may be used to analyze audio to detect the driver's vocalizations, and vehicle navigational sensors configured to detect how the driver handles the vehicle in response to the alert.

FIG. 4 is a functional block diagram illustrating components of an AI/ML ADAS drive policy management system 400 according to some embodiments. The AI/ML ADAS drive policy management system 400 includes an ADAS Policy Management layer 422 coupled to receive information from a plurality of components, including a context determination layer 412, a radar perception layer 414, a sensor perception layer 416, and one or more natural language modules 406. Vehicle sensors 402 provide information to the context determination layer 412, the radar perception layers 414, and the sensor perception layers 416. The one or more natural language models 406 receive voice input data 404 captured by a microphone that may be processed by the one or more natural language models 406 to infer the meaning of the voice input data 404. The ADAS Policy Management layer 422 selects one of the one or more vehicle driving policies for use by a vehicle control layer 424.

The sensors 402 correspond to one or more sensors 102-138 present in and about the vehicle to provide vehicle conditions and occupant data used by the AI/ML ADAS drive policy management system 400.

The content determination layer 412 determines a current vehicle context used to select a set of vehicle driving policies for use in controlling the vehicle behavior while in operation. The content determination layer 412 may utilize all available data, including the identity and number of occupants of the vehicle, a description of a destination, route, road and traffic conditions, event and time constraints on the completion of the travel route, and other related data relevant to determining how the vehicle behavior is to be controlled.

The radar perception layer 414 corresponds to the radar perception layer 362 as described in reference to FIGS. 3B and 3C. The radar perception layer 414 provides data relevant to the surroundings of the vehicle 101 when determining actions to be taken to control the vehicle behavior at a point in time.

The sensor perception layer 416 corresponds to sensor perception layers 354, 364, as described in reference to FIGS. 3B and 3C. The sensor perception layer 416 provides data relevant to the surroundings of the vehicle 101 when determining actions to be taken to control the vehicle's behavior at a point in time.

The voice input data 404 corresponds to a processing layer coupled to one or more microphones configured to detect auditory sounds in and about the vehicle 101. The voice input data 404 may detect sounds about the vehicle 101 that may suggest a condition regarding the vehicle 101 that may be useful to consider when determining actions to be taken to control the vehicle's behavior at a point in time.

The voice input data 404 may also voice commands or statements by the driver, as well as conversations between occupants of the vehicle 101 that may be processed by one or more natural language models 406 to infer the intent of one or more of the occupants of the vehicle 101 relevant to determining a vehicle context and selecting a set of vehicle driving policies used to control vehicle behavior.

The ADAS Policy Management layer 422 corresponds to a processing layer that receives data from the content determination layer 412, the radar perception layer 414, the sensor perception layer 416, the voice input data 404, and one or more natural language models 406 to select a current set of vehicle driving policies from one or more vehicle driving policies used to control vehicle behavior.

The vehicle control layer 424 corresponds to a processing layer that receives the current set of vehicle driving policies from the ADAS Policy Management layer 422 to determine operations needed to be performed to control vehicle behavior in a safe mode of operation consistent with the vehicle driving preferences of the driver and passengers of the vehicle 101. The current set of vehicle driving policies may consist of a default set of vehicle driving policies provided by the original equipment manufacturer (OEM) supplier of the vehicle 101.

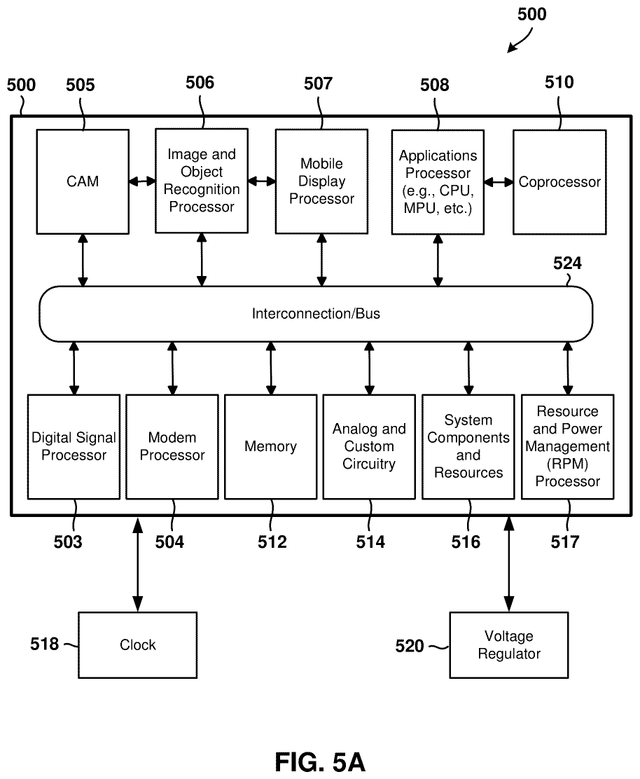

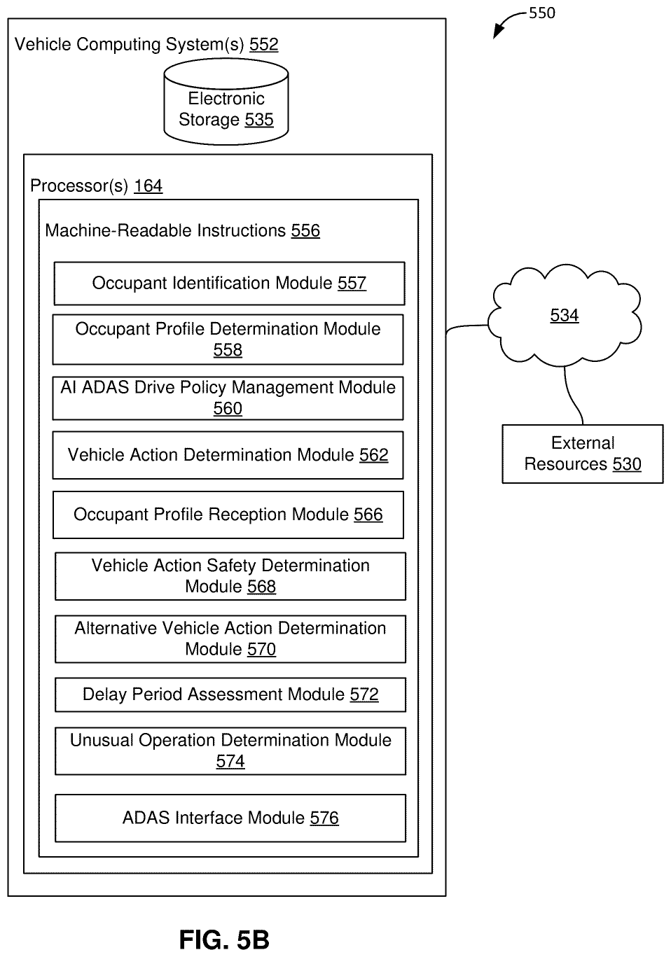

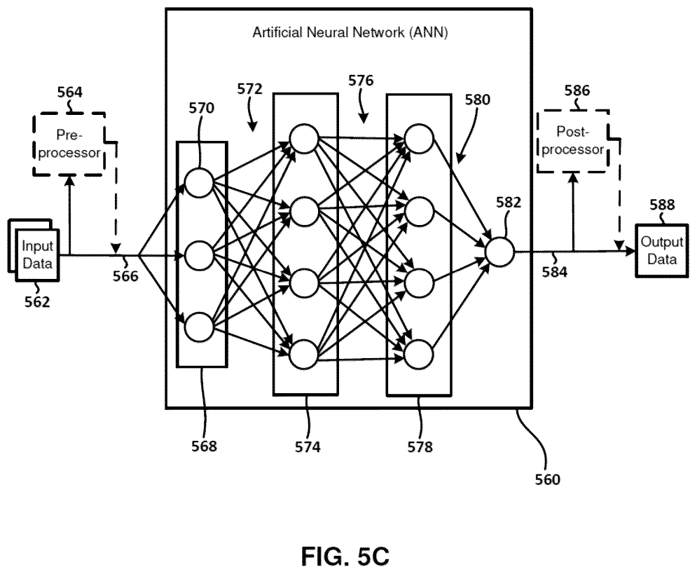

FIGS. 5A and 5B are schematic block diagrams illustrating components of an example system on chip for use in a vehicle in accordance with various embodiments. FIG. 5A illustrates an example system-on-chip (SOC) architecture of a processing device SOC 500 suitable for implementing various embodiments in vehicles. With reference to FIGS. 1-5A, the processing device SOC 500 may include a number of heterogeneous processors, such as a digital signal processor (DSP) 503, a modem processor 504, an image and object recognition processor 506, a display processor 507, an applications processor 508, and a resource and power management (RPM) processor 517. The processing device SOC 500 may also include one or more coprocessors 510 (e.g., vector co-processor) connected to one or more of the heterogeneous processors 503, 504, 506, 507, 508, 517. Each of the processors may include one or more cores, and an independent/internal clock. Each processor/core may perform operations independent of the other processors/cores. For example, the processing device SOC 500 may include a processor that executes a first type of operating system (e.g., FreeBSD, LINUX, OS X, etc.) and a processor that executes a second type of operating system (e.g., Microsoft Windows). In some embodiments, the applications processor 308 may be the SOC's 500 main processor, central processing unit (CPU), microprocessor unit (MPU), arithmetic logic unit (ALU), etc. The graphics processor 506 may be graphics processing unit (GPU).

The processing device SOC 500 may include analog circuitry and custom circuitry 514 for managing sensor data, analog-to-digital conversions, wireless data transmissions, and for performing other specialized operations, such as processing encoded audio and video signals for rendering in a web browser. The processing device SOC 500 may further include system components and resources 516, such as voltage regulators, oscillators, phase-locked loops, peripheral bridges, data controllers, memory controllers, system controllers, access ports, timers, and other similar components used to support the processors and software clients (e.g., a web browser) running on a computing device.

The processing device SOC 500 also include specialized circuitry for camera actuation and management (CAM) 505 that includes, provides, controls and/or manages the operations of one or more cameras 122, 136 (e.g., a primary camera, webcam, a three-dimension (3D) camera, etc.), the video display data from camera firmware, image processing, video preprocessing, video front-end (VFE), in-line JPEG, high definition video codec, etc. The CAM 505 may be an independent processing unit and/or include an independent or internal clock.

In some embodiments, the image and object recognition processor 506 may be configured with processor-executable instructions and/or specialized hardware configured to perform image processing and object recognition analyses involved in various embodiments. For example, the image and object recognition processor 506 may be configured to perform the operations of processing images received from cameras (e.g., 122, 136) via the CAM 505 to recognize and/or identify when a person or object occupies or is attempting to occupy the vehicle, as well as vehicle parts configurations, and otherwise perform functions of the camera perception layer (e.g., 220) as described. In some embodiments, the processor 506 may be configured to process sensor data and perform functions of the sensor perception layer (e.g., 210) as described.

The system components and resources 516, analog and custom circuitry 514, and/or CAM 505 may include circuitry to interface with peripheral devices, such as cameras (e.g., 122, 136), sensors, electronic displays, wireless communication devices, external memory chips, etc. The processors 503, 504, 506, 507, 508 may be interconnected to one or more memory elements 512, system components and resources 516, analog and custom circuitry 514, CAM 505, and RPM processor 517 via an interconnection/bus module 524, which may include an array of reconfigurable logic gates and/or implement a bus architecture (e.g., CoreConnect, AMBA, etc.). Communications may be provided by advanced interconnects, such as high-performance networks-on chip (NoCs).

The processing device SOC 500 may further include an input/output module (not illustrated) for communicating with resources external to the SOC, such as a clock 518 and a voltage regulator 520. Resources external to the SOC (e.g., clock 518, voltage regulator 520) may be shared by two or more of the internal SOC processors/cores (e.g., a DSP 503, a modem processor 504, a graphics processor 506, an applications processor 508, etc.).

In some embodiments, the processing device SOC 500 may be included in a control unit (e.g., 140) for use in a vehicle (e.g., 101). The control unit may include communication links for communication with a telephone network (e.g., through a network transceiver), the Internet, and/or a network server.

The processing device SOC 500 may also include additional hardware and/or software components that are suitable for collecting sensor data from sensors, including motion sensors (e.g., accelerometers and gyroscopes of an IMU), user interface elements (e.g., input buttons, touch screen display, etc.), microphone arrays, sensors for monitoring physical conditions (e.g., location, direction, motion, orientation, vibration, pressure, etc.), cameras, compasses, Global Positioning System (GPS) receivers, communications circuitry (e.g., Bluetooth®, WLAN, Wi-Fi, etc.), and other well-known components of modern electronic devices.

As used herein, the terms “component,” “system,” “unit,” and the like include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

FIG. 5B is a component block diagram of an example vehicle computing system 550 configured for operating the vehicle based on a current vehicle context determined by an AI/ML ADAS drive policy management system 400 according to some embodiments. In some embodiments, the system 550 may include external resources 530 communicating via a network 534, such as a wireless wide area network coupled to the Internet. With reference to FIGS. 1A-5B, the vehicle processing system 552 may include a processor (e.g., 164), a processing device (e.g., 500), and/or a control unit (e.g., 140) (variously referred to as a “processor”) of a vehicle (e.g., 101). The vehicle processing system 552 implements the AI/ML ADAS drive policy management system 400, as described with reference to FIG. 4, within an AI/ML ADAS drive policy management module 562.

The vehicle processing system 552 may include one or more processors 164 that may be configured by machine-executable instructions 556 to perform various operations, including operations of various embodiments. Machine-executable instructions 556 may include one or more instruction modules. The instruction modules may include computer program modules. The instruction modules may include (but is not limited to) one or more of a occupant identification module 557, occupant profile determination module 558, AI/ML ADAS drive policy management system 400, vehicle action determination module 562, occupant profile reception module 566, vehicle action safety determination module 568, alternative vehicle action determination module 570, delay period assessment module 572, unusual operation determination module 574, ADAS interface module 576, and/or other instruction modules.

The occupant identification module 557 may be configured to identify an occupant (i.e., the driver, and one or more passengers in the vehicle). In some embodiments, the occupant identification module 557 may be configured to identify an occupant based on (but not limited to) at least one of a position of the occupant in the vehicle, an input by the occupant, or recognition of the occupant. For instance, the input by the occupant and/or the recognition of the occupant may be determined from occupants through their portable computing device (e.g., a smartphone) or from identification using sensors (e.g., 102-138), such as (but not limited to) using biosensor(s), and/or facial recognition systems. By way of a non-limiting example, one or more processors 164 of the processing system 552 may use the electronic storage 535, external resources 530, one or more sensor(s) (e.g., 102-138), and a profile database (e.g., 142) to identify occupants or locations within the vehicle in which occupants are seated.

The occupant profile determination module 558 may be configured to determine one or more profiles or fine tuned AI/ML models configured or trained to identify or infer selected or adjusted ADAS driving policies appropriate or required for particular drivers and/or occupants. Determining the appropriate occupant profile may enable the ADAS to accommodate driving parameter preferences or requirements to implement when particular individuals are present in the vehicle. In this module, a processor (e.g., 164) of a processing device (e.g., 550) may use the electronic storage 535, a profile database and occupant identification information to determine which occupant profile to use based on current conditions or vehicle context. The profile database and/or the occupant profile determination module 558 may maintain a plurality of occupant profiles that include an occupant profile for designated individuals. Some implementations may not employ the occupant profile determination module 558 and more directly apply a predetermined occupant profile. Alternatively, the use of the occupant profile determination module 558 may be selectively turned on or off as needed or desired, which may be decided manually or automatically based on context, circumstances and/or conditions.

In circumstances in which more than one occupant occupies the vehicle, the occupant profile determination module 558 may also be configured to determine vehicle driving policy preferences of one or more of those occupants. In some embodiments, the occupant profile determination module 558 may determine occupant vehicle driving policy preferences according to a hierarchy. Using sensors (e.g., 102-138) the occupant profile determination module 558 may determine that the vehicle has multiple occupants and also determine which of the occupant(s) is/are in charge (e.g., the designated driver, vehicle owner, supervising adult, etc.). In some embodiments, an occupant of the driver's seat (or other pre-set location of the vehicle) may be selected as the designated driver by default, unless an override is received. Alternatively, both front seat occupants may be designated drivers since they tend to have a good view of the roadway.

In some embodiments, the designated driver may be chosen after an input from the occupants, such as from an associated mobile device or a direct input into the vehicle. In some embodiments, the input regarding the designated driver may also be received automatically from occupants, such as through the occupant identification module 557. In some embodiments, when determining the designated driver through identification, the occupant profile determination module 558 may automatically apply a hierarchy. For example, the owner or the most common or most recent designated driver may have top priority for being identified as the designated driver. Similarly, a hierarchical list may be pre-programmed or user-defined (e.g., (e.g., dad>mom>oldest child, or dad and mom>oldest child). In some embodiments, there may be no hierarchy, with vehicle-control gestures and vocal commands accepted from all or some occupants.

In some embodiments, priority among designated drivers or a selection of a new designated driver may occur in response to a trigger event, such as automatically. A non-limiting example of such a trigger event may be detection of a change in behavior of the current designated driver (or designated driver with highest priority) based on data from one or more sensors and/or by the vehicle control system. Non-limiting examples of change in behavior triggering a change in the determined designated driver include slowing reaction times due to fatigue, distraction, inebriation, and the like. For example, a camera system tracking the designated driver's eyes may detect eyelid droop from fatigue, that the driver is not watching the road due to distraction, or that the designated driver's eyes are moving slowly due to inebriation. Another non-limiting example of such a trigger event may be detection of a command (e.g., verbal command or command gesture) by the current designated driver (or designated driver with highest priority), another occupant, or a remote party (e.g., owner of the vehicle) received by a wireless communication link.

In some embodiments, the occupant profile determination module 558 may receive inputs from sensors (e.g., 102-138), such as cameras, alcohol sensors, motion detectors, or the like and apply occupant motion pattern recognition to determine a level of impairment of an occupant. In response to the occupant profile determination module 558 detecting that a designated driver (or designated driver with highest priority) is impaired, the occupant profile determination module 558 may be configured to select a new designated driver or change a priority of designated drivers.

The vehicle action determination module 562 may be configured to determine which vehicle action or actions is/are associated with detected occupant voice commands or hints, and/or vehicle-control gestures. The vehicle action determination module 562 may also be configured to determine alternative vehicle actions, when detected vehicle-control commands, hints and/or gestures are associated with actions that are not safe to the vehicle and/or occupants, or unusual in some way. In this module, the vehicle action determination module 562 may use a processor (e.g., 164) of a processing device (e.g., 550), the electronic storage 535, and an AI/ML ADAS drive policy management system (e.g., 400,) to determine vehicle actions.

The occupant profile reception module 566 may be configured to receive and store occupant profiles. The occupant profile reception module 556 may receive occupant profiles as input data through a vehicle user interface or from another computing device providing such data. Additionally, or alternatively, the occupant profile reception module 556 may receive occupant profiles that are customized to an occupant from training inputs. For example, a driver may program a set of preferred alternative driving profiles that the ADAS should implement based on defined circumstances or context (e.g., the presence of particular people, characterizations of an occupant, weather conditions, time of day, etc.) according to the driver's own preferences or needs. As a further example, a remote computing device may provide one or more occupant profiles to the occupant profile reception module 556 for the ADAS, such as a fleet operators preferred driving parameters in particular contexts. In this module, a processor (e.g., 164) of a processing device (e.g., 550) may use the electronic storage 535, one or more sensor(s) (e.g., 102-138), and input devices for receiving occupant profiles.

The vehicle action safety determination module 568 may be configured to determine whether a vehicle action associated with a driver or occupant input (e.g., voiced command or hint) is safe for the vehicle to execute under the present circumstances. The determination of safety may ensure no damage or injury to the vehicle or the occupants. Typically, what is safe for the vehicle is also safe for the occupants and vice versa (i.e., a level of risk to vehicle safety is equal to or approximate to a level of risk to occupant safety), but perhaps not always. For example, an extremely rapid deceleration may cause whiplash to an occupant, while the vehicle may sustain no damage. Thus, the determination of what is safe will generally prioritize the safety of the occupant(s). In this module, a processor (e.g., 164) of a processing device (e.g., 550) may use the electronic storage 535, and the AI/ML ADAS drive policy management system (e.g., 400) to determine or assess the safety of various vehicle actions.

In some implementations, the alternative vehicle action determination module 570 may be configured to determine one or more alternative vehicle actions (e.g., changing speed(s), changing to a different lane(s), etc.) that may be safer than a voiced command or consistent with a hint voiced by an occupant. The alternative vehicle action determination module 570 may be used in response to determining that a vehicle action commanded by the driver or planned by the ADAS before recognizing a verbalized hint is not safe for the vehicle to execute. For example, if the driver suggests verbally that the vehicle should change lanes to a lane such that the vehicle will be traveling behind another vehicle. That first vehicle action may be relatively safe, but there may be a statistical chance (i.e., relatively small) that the vehicle in the lead could slam on its brakes soon after the lane change (i.e., a first level of risk to safety). Meanwhile, an alternative vehicle action may include first overtaking that vehicle in the lane before changing lanes, which may be associated with a lower statistical chance of the vehicle becoming involved in an accident because of the open road ahead of that lead vehicle. That may be the case when a second level of risk to safety based on the alternative vehicle action is lower than the first level of risk to safety of the originally selected or indicated action. In this module, a processor (e.g., 164) of a processing device (e.g., 550) may use the electronic storage 535, and an AI/ML ADAS drive policy management system (e.g., 400) to determine alternative vehicle actions.

The delay period assessment module 572 may be configured to determine whether a reasonable delay after a verbalized command or hint may make an otherwise unsafe vehicle action safe enough for the vehicle to execute. In some embodiments, a maximum delay threshold, such as (but not limited to) 5-10 seconds, may be used to limit the duration of delay periods that may be considered by the delay period assessment module 572. The maximum delay threshold may be set and/or changed by an occupant, vehicle owner, and/or manufacturer. In addition, the maximum delay threshold may be different for each occupant or driver (i.e., associated with an occupant profile). Alternatively, the maximum delay threshold may be universal for all occupants. As a further alternative, while individual occupants may have different maximum delay thresholds, the vehicle may also have an ultimate maximum delay threshold that the individual maximum delay thresholds may not exceed. In this module, a processor (e.g., 164) of a processing device (e.g., 550) may use the electronic storage 535, and an AI/ML ADAS drive policy management system (e.g., 400) to determine or assess delay periods for executing various vehicle actions,

The unusual operation determination module 574 may be configured to determine whether a vehicle action associated with a vehicle-control gesture or verbal command includes an unusual vehicle operation. Unusual operations may include vehicle operations that are not habitually or commonly performed by the vehicle, such as compared to the same vehicle's operations in the past, other vehicles or similar vehicles, and vehicles under similar circumstances (e.g., location, time of day/year, weather conditions, etc.)., For example, unusual operations may include a sudden action or actions that are significantly more extreme than actions typically performed by the vehicle. Whether a vehicle action is considered unusual may depend on whether that vehicle action has been performed before, as well as the speed, acceleration/deceleration, degree, and extent of the vehicle action. In the case of vehicle actions that have been performed before, but just not at the same speed, degree, and/or extent, the processor may use a threshold that, once exceeded, makes that vehicle action unusual.

The ADAS interface module 576 may be configured to interface with the vehicle's ADAS to identify selected or adjusted ADAS driving policies that should be implemented, and/or to provide inferred hints to the ADAS for consideration. In this module, the ADAS interface module 576 may use a processor (e.g., 164) of a processing system (e.g., 550), electronic storage 535, and an AI/ML ADAS drive policy management system (e.g., 400) to operate the vehicle (e.g., execute vehicle actions).

In some embodiments, the vehicle processing system 552 and other vehicle computing system(s) 554 may be connected to wireless communication networks that provide access to external resources 530. For example, such electronic communication links may be established, at least in part, via a network such as wireless communication links (e.g., a wide area wireless access network) to a connection to the Internet and/or other networks.

External resources 530 may include sources of information outside of system 550, external entities participating with the system 550, and/or other resources that may provide information useful for determining a context of the vehicle. For example, external resources 530 may include map data resources, highway information (e.g., traffic, construction, etc.) systems, weather forecast services, etc. In some embodiments, some or all of the functionality attributed herein to external resources 530 may be provided by resources included in system 550.

The vehicle processing system 552 may include electronic storage 535, one or more processors 164, and/or other components. The vehicle processing system 552 may include communication lines or ports to enable the exchange of information with a network and/or other vehicle computing system. The illustration of the vehicle processing system 552 in FIG. 5B is not intended to be limiting. The vehicle processing system 552 may include a plurality of hardware, software, and/or firmware components operating together to provide the functionality attributed herein to vehicle computing system(s) 552. For example, the vehicle processing system 552 may be implemented by a cloud of vehicle computing systems operating together as vehicle computing system(s) 552.

Electronic storage 535 may include non-transitory storage media that electronically stores information. The electronic storage media of electronic storage 535 may include one or both of system storage that is provided integrally (i.e., substantially non-removable) with vehicle processing system 552 and/or removable storage that is removably connectable to vehicle processing system 552 via, for example, a port (e.g., a universal serial bus (USB) port, a firewire port, etc.) or a drive (e.g., a disk drive, etc.). Electronic storage 535 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 535 may store software algorithms, information determined by processor(s) 164, information received from vehicle computing system(s) 552, information received from other vehicle computing system(s) 554, and/or other information that enables vehicle processing system 552 to function as described herein.

The processor(s) 164 may be configured to provide information processing capabilities in vehicle computing system(s) 552. As such, the processor(s) 164 may include one or more of a digital processor, an analog processor, a digital circuit designed to process information, an analog circuit designed to process information, a state machine, and/or other mechanisms for electronically processing information. Although the processor 164 is shown in FIG. 5B as a single entity, this is for illustrative purposes only. In some embodiments, the processor(s) 164 may include a plurality of processing units. Such processing units may be physically located within the same device, or the processor(s) 164 may be the processing functionality of a plurality of devices operating in coordination. The processor(s) 164 may be configured to execute modules 558, 557, 560, 562, 566, 568, 570, 572, 574, and/or 576, and/or other modules. The processor(s) 164 may be configured to execute modules 558, 557, 560, 562, 566, 568, 570, 572, 574, and/or 576, and/or other modules by software; hardware; firmware; some combination of software, hardware, and/or firmware; and/or other mechanisms for configuring processing capabilities on processor(s) 164. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 558, 557, 560, 562, 566, 568, 570, 572, 574, and/or 576, and/or other modules are illustrated in FIG. 5B as being implemented within a single processing unit, in embodiments in which processor(s) 164 includes multiple processing units, one or more of modules 558, 557, 560, 562, 566, 568, 570, 572, 574, and/or 576, may be implemented remotely from the other modules. The description of the functionality provided by the different modules 558, 557, 560, 562, 566, 568, 570, 572, 574, and/or 576 described below is for illustrative purposes, and is not intended to be limiting, as any of modules 558, 557, 560, 562, 566, 568, 570, 572, 574, and/or 576, may provide more or less functionality than is described. For example, one or more of modules 558, 557, 560, 562, 566, 568, 570, 572, 574, and/or 576 may be eliminated, and some or all of its functionality may be provided by other ones of modules 558, 557, 560, 562, 566, 568, 570, 572, 574, and/or 576. As another example, processor(s) 164 may be configured to execute one or more additional modules that may perform some or all of the functionality attributed below to one of modules 558, 557, 560, 562, 566, 568, 570, 572, 574, and/or 576.

FIG. 5C is a block diagram illustrating an example machine learning (ML) model represented by an artificial neural network (ANN) 560 suitable for use in various embodiments. A variety of different types of AI/ML models may be used in some embodiments. An ML model based on an ANN is used as an illustrative, but it should be understood that other types of ML models may be used instead of or in addition to an ANN.

An ANN 560 may receive input data 566, which may include one or more bits of data 562, pre-processed data output from pre-processor 564 (optional), or some combination thereof. Such input data 562 may include training data, verification data, and vehicle sensor data, depending on whether the ANN 560 is in training, verification, or operation, respectively. A pre-processor 564 may be included within ANN 560 in some embodiments. A pre-processor 564 may, for example, process all or a portion of the input data 562, which may result in some of the data 562 being changed, replaced, deleted, etc. In some embodiments, the pre-processor 564 may add additional data to the data 562. In some embodiments, the pre-processor 564 may be an ML model, such as another ANN. In some embodiments, the pre-processor 564 may be or include sensor processing modules, such as image processing modules, radar/lidar processing modules, etc.

The example ANN 560 includes just four layers 568, 574, 578, 582 for ease of description. However, an ANN will typically include many more layers. In the illustrated example ANN 560, a first layer 568 of artificial neurons 570 processes input data 566 and provides resulting first layer data via connections or “edges,” such as edges 572, to at least a portion of a second layer 574. The second layer 574 processes data received via edges 572 and provides second layer output data via edges 576 to at least a portion of a third layer 578. The third layer 578 processes data received via edges 576 and provides third layer output data via edges 580 to at least a portion of a final layer 582 including one or more neurons to provide output data 584. All or part of the output data 584 may be further processed in some manner by an optional post-processor 586. Thus, in some implementations, an ANN 560 may provide output data 588 that is based on output data 584, post-processed data output from post-processor 586, or some combination thereof.

The post-processor 586 may be included within the ANN 560 in some embodiments, or may be or include another ANN or other ML model. The post-processor 586 may, for example, process all or a portion of the output data 584, which may result in output data 588 being different, at least in part, than the output data 584 of the ANN 560, such as the result of data being changed, replaced, deleted, etc. In some embodiments, the post-processor 586 may be configured to add additional data to the output data 584.

In the example ANN 560 illustrated in FIG. 5C, the second layer 574 and the third layer 578 may be intermediate or hidden layers that may be arranged in a hierarchical or another like structure. Although not explicitly shown, there may be one or more further intermediate layers between the second layer 574 and the third layer 578. Within a given layer, such as the first layer 568, second layer 574, or third layer 578 of an ANN 560, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer.

Artificial neurons in each layer may be activated by or be responsive to parameters, such as the weights and biases of the ANN 560. The weights and biases of the ANN 560 may be adjusted during a training process or during operation of the ANN 560. The weights of the various artificial neurons may control the strength of connections between layers or artificial neurons, while the biases may control the direction of connections between the layers or artificial neurons. An activation function may select or determine whether an artificial neuron transmits its output to the next layer or not in response to its received data.

The structure and training of artificial neurons 570 in the various layers of an ANN 560 may be tailored to specific requirements of providing inferences based on vehicle context information and/or user voice inputs. Different activation functions may be used to model different types of non-linear relationships. By introducing non-linearity into an ML model, an activation function allows the configuration for the ML model to change in response to identifying or detecting complex patterns and relationships in the input data 566. Some non-limiting activation functions include a sigmoid-based activation function, a hyperbolic tangent (tanh) based activation function, a convolutional activation function, up-sampling, pooling, and a rectified linear unit (ReLU) based activation function.

Training of an ML model, such as ANN 560, may be conducted using training data. Training data may include one or more datasets that the ANN 560 may use in a machine learning process that will adjust model parameters (such as the weights and biases) of artificial neurons 570 based on patterns or relationships that exist in the training data. Training data may represent various types of information, including written, visual, audio, environmental context, operational properties, etc., with data reflective of the type of information that will be received as inputs by the trained ANN correlated or associated with appropriate outputs or inferences (sometimes referred to as “ground truth” information). During training, the model parameters are adjusted through a machine learning process to minimize or otherwise reduce a loss function or a cost function that reflects differences between the ANN output and the ground truth output/inference corresponding to input data. The training process may be repeated multiple times to fine-tune the ANN 560 with each iteration.

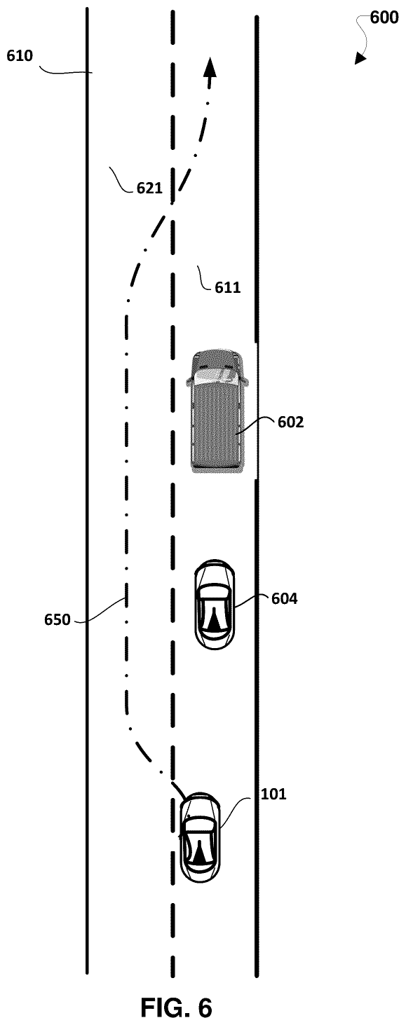

FIG. 6 is a vehicle highway diagram of an example vehicle control sequence by an AI/ML ADAS drive policy management system according to some embodiments. In the example 600 of the AI/ML ADAS drive policy management system 400, the vehicle 101 is traveling along a two-lane roadway 610 in a first travel lane 611 with a second travel lane 621 for traffic traveling in an opposite direction. Vehicle 101 is initially behind a slower moving vehicle 602 which is following behind a slower moving truck 602.

In this example 600 vehicle control sequence by the AI/ML ADAS drive policy management system 400, the driver of the vehicle 101 may be traveling to a train station (not shown) to pick up an arriving passenger. The arriving passenger is expected to arrive at the scheduled arrival time for a particular train at the train station. The driver desires to arrive at the train station in time to pick up the arriving passenger without causing this passenger to wait for any appreciable amount of time.

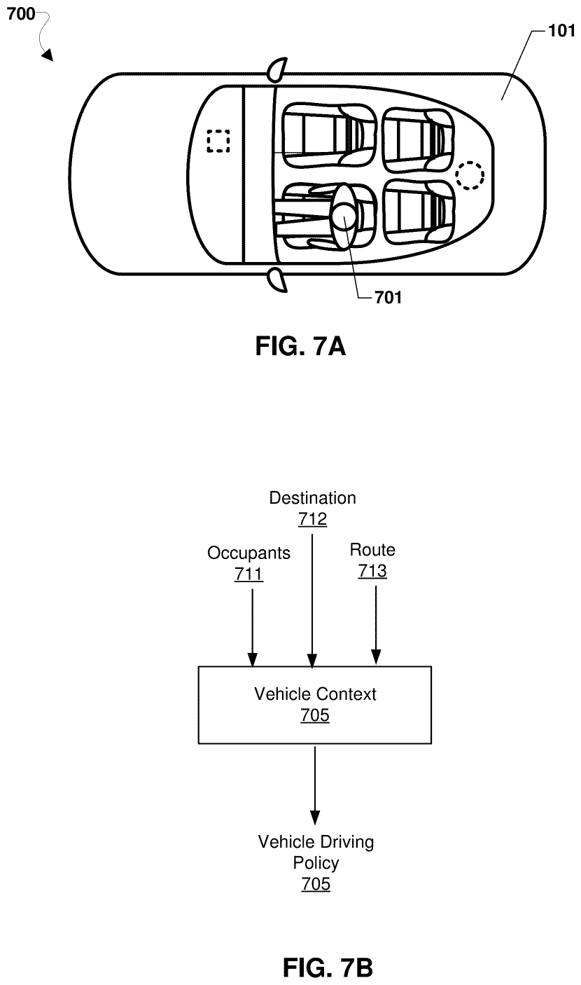

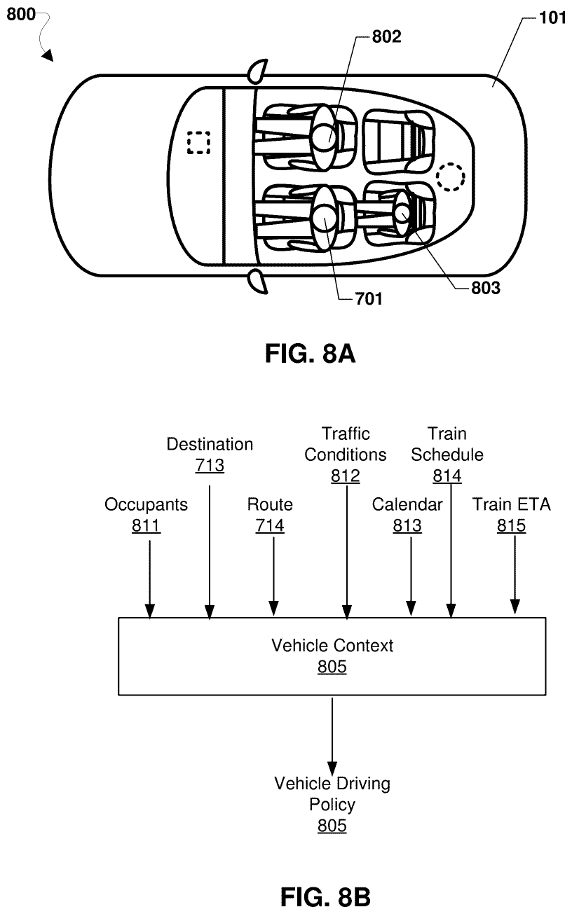

The AI/ML ADAS drive policy management system 400 selects a set of vehicle driving policies to operate the vehicle 101 along the travel route to the train station. The slower moving truck 602 and the slower moving vehicle 604 could delay the arrival of the vehicle 101 at the train station as long as the vehicle is forced to travel behind these slower moving vehicles 602-604. The driver of the vehicle 101 may wish to take a path of travel 650 that passes the slower moving truck 602 and the slower moving vehicle 604. Whether the vehicle is permitted to take a route of travel 650 that utilizes the second travel lane 621 depends upon the opposing traffic in the second travel lane 621 and the set of vehicle driving policies in use for controlling the behavior of the vehicle 101. As noted, the set of vehicle driving policies is selected based on the vehicle context determined to exist within the vehicle 101. Examples of various vehicle contexts are discussed with reference to FIGS. 7A-7B and 8A-8B.

FIGS. 7A and 7B illustrate example policy operations of an AI/ML ADAS drive policy management system according to some embodiments. FIG. 7A illustrates a vehicle 101 configured utilizing an AI/ML ADAS drive policy management system 400 in accordance with various embodiments. With reference to FIGS. 1A-7A, a processor (e.g., 164) of the vehicle 101 may receive sensor data from the vehicle 101 that identifies the vehicle context 705 for the vehicle 101 trip to the train station described with reference to FIG. 6. In this example 700, the driver 701 is traveling alone. The AI/ML ADAS drive policy management system 400 may detect that the driver is alone and may identify the driver 701 to be a known individual. The AI/ML ADAS drive policy management system 400 may obtain vehicle driving preferences associated with the driver 701 to be used to determine the vehicle context 705.

The vehicle context 705 of FIG. 7B may be based upon the identity of the occupants 711, the destination for the trip 712, and the route to be followed by the vehicle 101 to the destination. When the identity of the driver 701 is determined, the driver's vehicle driving preferences may be obtained. The driver's vehicle driving preferences may include a preferred vehicle speed, an acceptable level of risk when interacting with other vehicles, and a preferred level of punctuality for a trip. These preferences may be used to determine whether present conditions on the roadway 610 when the driver 701 desires to pass the slower moving truck 602 and the slower moving vehicle 604 are determined to be safe.

The destination 712 may include the address of the train station, the expected arrival time of the train carrying the arriving passenger, and an acceptable amount of delay in being picked up for the particular arriving passenger. These parameters associated with the destination 712 permit the AI/ML ADAS drive policy management system 400 to estimate whether the vehicle 101 will arrive at the train station before the arrival of the train and the corresponding arriving passenger. The determination whether present conditions on the roadway 610 when the driver 701 desires to pass the slower moving truck 602 and the slower moving vehicle 604 are determined to be safe may be adjusted based upon whether the vehicle is expected to arrive in time at the train station for the route to be taken.

For example, the driver may accept delaying an attempt to pass the slower vehicles until no opposing traffic is visible in the second travel lane 621 when the vehicle 101 is expected to arrive in advance of the arrival of the train. Similarly, the driver may not accept delaying an attempt to pass the slower vehicles, or at least be willing to attempt to pass the slower vehicles under higher traffic conditions when the vehicle 101 is expected to arrive after arrival of the train. The determination to attempt to pass the slower vehicles may similarly be based upon the acceptable amount of delay in being picked up for the particular arriving passenger. Other similar conditions identified from the sensor data may be used as appropriate to determine whether to attempt to pass the slower vehicles.

In accordance with various embodiments, a selected set of vehicle driving policies based upon a particular vehicle context 705 may be used to control the vehicle's behavior, which includes specification of acceptable conditions about the vehicle 101 for passing the slower moving vehicles.

FIGS. 8A and 8B illustrate another example policy operations of an AI/ML ADAS drive policy management system according to some embodiments. FIGS. 8A-8B illustrate a vehicle 101 taking the same trip to the train station as described with references to FIGS. 6-7A. In this example trip, however, the driver 701 is traveling with two additional passengers. For example, the driver 701 may be driving his mother-in-law 802 to pick up his father-in-law at the train station with his child 803 seated in the rear of the vehicle.

The addition of these two passengers 811, and their respective identities, may alter the vehicle context 805 determined to exist in the vehicle 101 compared to the vehicle context 705 when the driver 701 is traveling alone. In addition, the destination 712 and route 713 are identical to the example use case 700. Each of these additional passengers 811 may have individual vehicle driving preferences to be considered when the vehicle context 805 for the second example use case 800 is determined.

For example, the mother-in-law 802 may have a preference that the vehicle 101 be driven safely and with minimal risk, especially when a child 803 is present. This preference may result in a different determination of the current vehicle context used in selecting a different set of vehicle driving policies compared to the set of vehicle driving policies selected based upon the earlier determined vehicle context 705. As such, the vehicle 101 may attempt to pass the slower moving vehicles 602-604 at different times in the presence of similar traffic conditions.

The vehicle context 805 may also be based on additional data that includes a driver's calendar having additional data associated with the arrival of the train and the arriving passenger. The AI/ML ADAS drive policy management system 400 may access external resources 530 that provide train schedule information having more specific arrival time data. The external resources 530 may also provide an updated expected time of arrival (ETA) for the train. For example, the operator of the train service may provide current status information for all trains currently in service via a publicly accessible web site. Using this status information, the AI/ML ADAS drive policy management system 400 may determine an updated expected arrival of the train, and thus a more specific determination as to whether the vehicle 101 may arrive at the train station before the arrival of the train.

Similarly, current traffic conditions 812 for the route being taken by the vehicle 101 to the train station. The current traffic conditions 812 may also provide a more specific estimate as to whether the vehicle 101 may arrive at the train station before the arrival of the train. The current traffic conditions 812 may also result in selection of a set of vehicle driving policies that searches for an alternate route to the train station. In this module, additional data that may be useful in determining a vehicle context 805 includes current weather conditions about the route, time and location of drop off location, or subsequent event, location, time, to be travelled following picking up the arriving passenger at the train station, and similar data which may affect the selection of a set of vehicle driving policies.

Additionally, the vehicle context and corresponding selection of a set of vehicle driving policies may also be based upon voice input data 404 obtained by the sensors 402 that are part of the vehicle 101. For example, a microphone may capture the sound of an emergency siren approaching the vehicle 101. The AI/ML ADAS drive policy management system 400 may use this auditory information to apply a vehicle driving policy that permits an emergency vehicle to pass the vehicle 101. Other recognizable sounds that may provide information relevant to the determining conditions about the vehicle 101 captured and used to select and/or apply a set of vehicle driving policies to control vehicle behavior.

The voice input data 404 also may contain conversations and commands from the driver 701 and passengers 802-803 that are relevant to the determining vehicle context 805 for the vehicle 101 used to select and/or apply a set of vehicle driving policies to control vehicle behavior. As noted, the voice input data 404 may be processed by one or more natural large language models 406 (LLM) to infer relevant information within the content of the conversation that also is relevant to the determining conditions about the vehicle 101 captured and used to select and/or apply a set of vehicle driving policies to control vehicle behavior. For example, vehicle operation commands may be inferred from the voice input data 404. These vehicle operation commands may be translated to vehicle command codes, such as to “pull the vehicle over to the side of a roadway” that instruct the AI/ML ADAS drive policy management system 400 to perform this operation. The vehicle command codes may be submitted to the AI/ML ADAS drive policy management system 400 for processing as if otherwise received from a driver 701. As such, the AI/ML ADAS drive policy management system 400 may apply safety policies and similar analysis of current conditions about the vehicle 101 to perform the inferred request to pullover to the side of the roadway only when it may be safe to do so.

Additionally, the voice input data 404 may be processed by one or more large language models 406 to infer relevant information within the content of the conversation that defines and/or alters one or more occupant vehicle driving preferences. For example, the driver's mother-in-law 802 may have a vehicle driving preference that the driver should operate the vehicle 101 at or below a posted speed limit. As another example, the processed voice input data 404 may be inferred to suggest that the mother-in-law 802 strongly desires to arrive at the train station before the arrival of the train because of a need to provide the arriving passenger, her husband, with medication or other items available immediately upon arrival. Such an inferred preference may override the vehicle's driving preference to travel at or below the posted speed limit if needed to arrive at the train station at or before the arrival of the train.

The processed voice input data 404 may be inferred to suggest additional preferences associated with one or more of the occupants of the vehicle as well as associate an inferred preference with a particular identified occupant. For example, a passenger may discuss for the first time traveling in foul weather at posted speeds out of fear of an accident from hydroplaning, ice, and careless other drivers. If the AI/ML ADAS drive policy management system 400 has no data associated with this particular occupant regarding foul weather, the inferred suggestion may be suitable for including within a set of vehicle driving preferences associated with this occupant. The large language models 406 and the AI/ML ADAS drive policy management system 400 may insert this preference to drive slowly in foul weather into the vehicle driving preferences for that occupant.

Additionally, the processed voice input data 404 also may be inferred to suggest that a particular condition exists or may be detected about the vehicle 101 and its surroundings. In response to such an inference, the ADAS system may check for an observed condition corresponding to the inferred suggestion using sensor data 402, radar perceptions 414, and sensor perceptions 416. This check for conditions may enable the ADAS system to identify additional conditions about the vehicle 101 that need to be considered by the ADAS when applying vehicle driving policies to control vehicle behavior. For example, an occupant may exclaim to the driver to watch out for a young child near a crosswalk that appears to be about to enter the roadway. The AI/ML ADAS drive policy management system 400 may have not detected the young child until about to enter the roadway. By inferring that the occupant has provided a driving hint, the AI/ML ADAS drive policy management system 400 may initiate a search of sensor data for a child even before being detected, and may search in the direction of the suggested location, and then identify immediate corrective action or adjusted driving parameters to avoid striking the child should he or she enter the roadway. By the ADAS considering suggestions or hints regarding external conditions inferred from the voice input data 404, the ADAS may be able to take an appropriate driving action (e.g., slow, turn, etc.) before the condition might otherwise have been observed by the ADAS or detected by vehicle sensors, thereby reducing the risk of harm to vehicle occupants as well as individuals and property along the vehicle's path of travel.

The foregoing examples of inferences made by the AI/ML model based on the voice input data 404 are intended to be non-limiting, and there are many more types of inferences and appropriate ADAS responses based on captured conversations of occupants within the vehicle that may be accomplished by various embodiments.

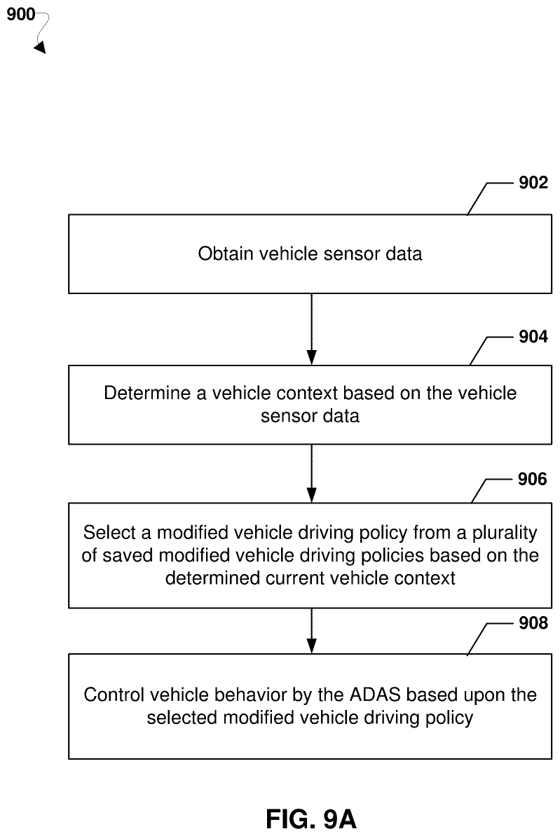

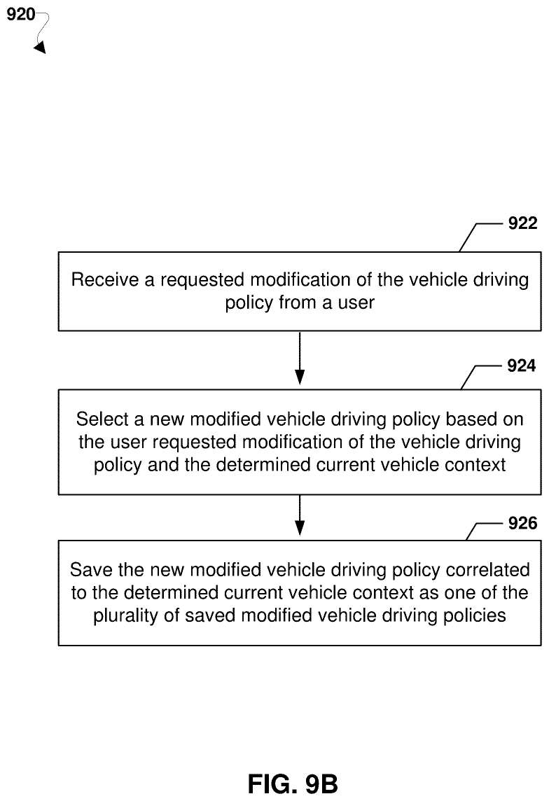

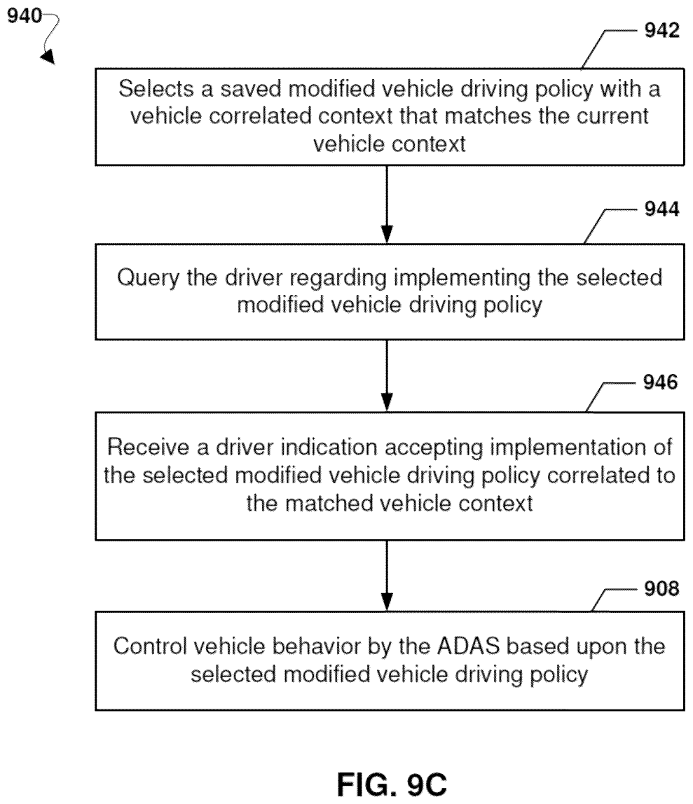

FIGS. 9A-9C are process flow diagrams illustrating a method 900 of an AI/ML ADAS drive policy management system according to some embodiments. With reference to FIGS. 1-9C, the operations of the method 900 may be performed by a processing system (e.g., 140, 312, 346, 500, 552) including one or more processors (e.g., 164, 314, 348, 503, 504, 506, 508, 510) and/or hardware elements, an AI/ML model (e.g., 560), any one or combination of which may be configured to perform any of the operations of the method 900. Further, one or more processors within the processing system may be configured with software or firmware to perform various operations of the method. To encompass any of the processor(s), AI/ML module(s), hardware elements and software elements that may be involved in performing the method 900, the elements performing method operations are referred to as a “processing system.” Further, means for performing functions of the method 900 may include the processing system (e.g., 140, 312, 346, 500, 552) including one or more processors (e.g., 164, 314, 348, 503, 504, 506, 508, 510), and memory (e.g., (166, 318, 342, 512, 534).

FIG. 9A illustrates a method of managing driving policies in a vehicle ADAS using a detected vehicle context according to some embodiments. The detected vehicle context corresponds to the recognized set of vehicle conditions used to select a set of vehicle driving policies consistent with the set of vehicle conditions at a particular point in time.

In block 902, the AI/ML ADAS drive policy management system 400 may obtain vehicle sensor data. Vehicle sensors may include any of the sensors described herein, including for example sensors within the vehicle (e.g., driver and occupant sensors, microphones, seat sensors, etc.) and external condition sensors (e.g., cameras, accelerometers, thermometers, moisture sensors, etc.).

In block 904, the AI/ML ADAS drive policy management system may determine a current vehicle context based on the vehicle sensor data. The determination of context may take into account data from selected sensors within the vehicle (e.g., driver and occupant sensors, microphones, seat sensors, etc.) as well as external condition sensors (e.g., cameras, accelerometers, thermometers, moisture sensors, etc.) that provide information related to circumstances and conditions that are relevant to an occupants driving preferences and/or safe vehicle operating considerations.

In block 906, the AI/ML ADAS drive policy management system 400 may process the context information as an input to produce as an output a selection of a particular modified vehicle driving policy from a plurality of saved modified vehicle driving policies. In the operations in block 906, the AI/ML ADAS drive policy management system 400 may use the determined current vehicle context, as well as vehicle status information and vehicle sensor, to reach an inference regarding which of the plurality of modified driving policies is appropriate to implement.

In block 908, the AI/ML ADAS drive policy management system 400 may communicate with the vehicle ADAS to implement the selected modified vehicle driving policy resulting in the ADAS controlling vehicle behavior based on the selected modified vehicle driving policy. Controlling the vehicle by the ADAS based upon the selected modified vehicle driving policy may include modifying one or more of a steering, braking, or acceleration policies of the vehicle ADAS control algorithms.

FIG. 9B illustrates additional operations 920 included in method 900 for managing driving policies in a vehicle ADAS using a detected vehicle context according to some embodiments. In block 922, the AI/ML ADAS drive policy management system 400 may receive a requested modification of the vehicle driving policy from a user. In some embodiments, a driver may explain, either verbally or via a keyboard or similar user interface, circumstances or contexts in which the ADAS should operate a particular manner. For example, the driver may verbally explain (which the AI/ML module may understand from outputs of an LLM) that when a particular person (e.g., aged parent, handicapped person, or baby) is in the vehicle (the context), the ADAS should adopt a gentle ride driving policy (the corresponding modified driving policy), such as reducing maximum speeds, acceleration and deceleration rates, reducing turning rates, and the like. As another example, the driver may verbally explain that when there are no passengers in the vehicle with the driver (the context), the ADAS should adopt a sporty driving policy, such as increasing maximum speeds, adopting maximum acceleration and deceleration rates, maximizing acceptable turning rates, and the like. In some embodiments, a request to modify a vehicle driving policy may be inferred during operation, such as in response to receiving a driver command (e.g., “slow down”), and relate the modified driving policy to the current context (e.g., speed, driving conditions, occupants, etc.) of the vehicle.

In block 924, the AI/ML ADAS drive policy management system 400 may generate a newly modified vehicle driving policy based on the user-requested modification of the vehicle driving policy and the specified or determined current vehicle context, and in block 926, saves the newly modified vehicle driving policy correlated to the identified or determined current vehicle context as one of the plurality of saved modified vehicle driving policies. The newly modified vehicle driving policies may be saved in a database maintained in a memory within the vehicle accessible by the vehicle processing system.

FIG. 9C illustrates additional operations 940 performed when generating a modified vehicle driving policy from the plurality of saved vehicle policies in block 924 for managing driving policies in a vehicle ADAS using a detected vehicle context according to some embodiments. In block 942, the AI/ML ADAS drive policy management system 400 selects a modified vehicle driving policy from the plurality of saved vehicle policies of block 924 by determining whether the determined vehicle context matches a vehicle context correlated to one of the pluralities of saved modified vehicle driving policies.

In block 944, the AI/ML ADAS drive policy management system 400 may query the driver regarding implementing the modified vehicle driving policy selected in response to the determined vehicle context matching a vehicle context correlated to one of the pluralities of saved modified vehicle driving policies.

In block 946, the AI/ML ADAS drive policy management system 400 may receive a driver indication accepting implementation of the saved modified vehicle driving policy correlated to the matched vehicle context.

In block 908, the AI/ML ADAS drive policy management system 400 may implement the selected modified vehicle driving policy in response to the received driver acceptance indication, and control the vehicle accordingly as described for the like numbered block in the method 900.

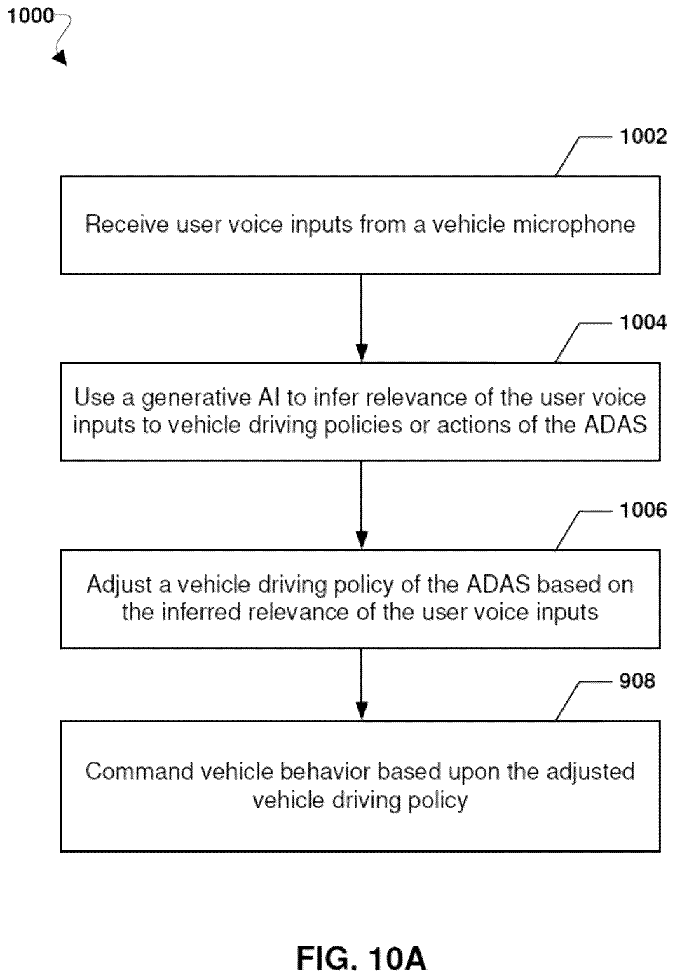

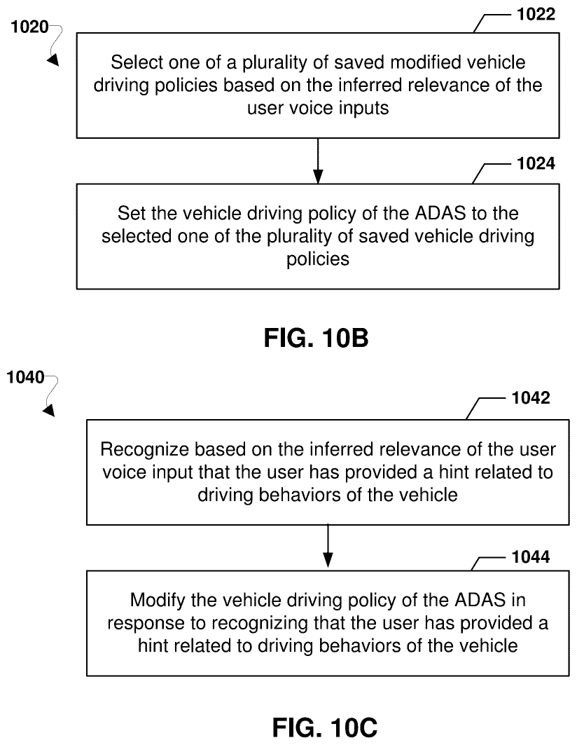

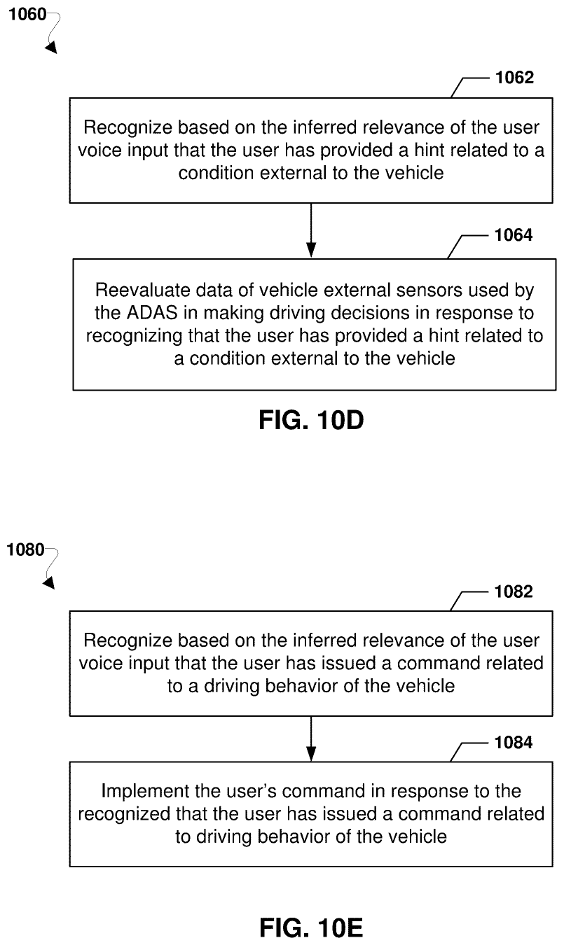

FIGS. 10A-10E are process flow diagrams illustrating a method 1000 of an AI/ML ADAS drive policy management system according to some embodiments. With reference to FIGS. 1-10E, the operations of the method 1000 may be performed by a processing system (e.g., 140, 312, 346, 500, 552) including one or more processors (e.g., 164, 314, 348, 503, 504, 506, 508, 510) and/or hardware elements, an AI/ML model (e.g., 560), any one or combination of which may be configured to perform any of the operations of the method 900. Further, one or more processors within the processing system may be configured with software or firmware to perform various operations of the method. To encompass any of the processor(s), AI/ML module(s), hardware elements and software elements that may be involved in performing the method 1000, the elements performing method operations are referred to as a “processing system.” Further, means for performing functions of the method 1000 may include the processing system (e.g., 140, 312, 346, 500, 552) including one or more processors (e.g., 164, 314, 348, 503, 504, 506, 508, 510), and memory (e.g., (166, 318, 342, 512, 534).

FIG. 10A illustrates a method 1000 for managing driving policies in a vehicle ADAS based on detected vehicle context information inferred by an AI/ML module according to some embodiments. In block 1002, the AI/ML ADAS drive policy management system 400 may receive or detect user voice inputs from a vehicle microphone or microphones. For example, the sounds of the driver and/or vehicle occupants speaking may be picked up by one or more microphones within the vehicle and processed by a voice recognition model to output text representative of the user's speech.

In block 1004, the AI/ML ADAS drive policy management system 400 may use a generative large language model (LLM) AI module that is trained to infer the relevance of the user voice inputs to vehicle driving policies or actions of the ADAS. In some embodiments, the LLM may receive text output by a voice recognition model and make the inference based on the input text. In some embodiments, the LLM may process voice input data directly and make the inference base on the voice sounds recorded by the one or more microphones. As part of the operations in block 1004, the AI/ML ADAS drive policy management system 400 may process the verbalizations to infer whether they involve a command, a selected modified driving policy, or merely a hint for the ADAS to consider in the operations of the vehicle.

In block 1006, the AI/ML ADAS drive policy management system 400 may adjust a vehicle driving policy of the ADAS based on the inferred relevance of the user voice inputs. When the LLM infers that the verbalizations included a command or selected modified driving policy, the AI/ML ADAS drive policy management system 400 may implement or evaluate implementing the command or driving policy. When the LLM infers that the verbalizations included a hint, the AI/ML ADAS drive policy management system 400 may include the hint as part of the driving decision making.

For example, in response to inferring in block 1004 that the user has verbalized a command (e.g., slow down, speed up, stop, pass the vehicle ahead, etc.), the AI/ML ADAS drive policy management system 400 may adjust the current driving policy or plan to consider implementing the verbalized command. As described, the policy system and/or ADAS may also evaluate the safety or feasibility of the verbalized command and implement the command only if and when safe to do so.

As another example, in response to inferring in block 1004 that the user has verbalized request implementation of a stored modified ADAS driving policy (e.g., my father is in the car, there is a baby onboard, etc.), the AI/ML ADAS drive policy management system 400 may select and implement a modified ADAS driving policy consistent with the inferred intent of the user's verbalization.

As another example, in response to inferring in block 1004 that the user has verbalized a hint (e.g., watch out, see the child on the sidewalk, that car is driving suspiciously, etc.), the AI/ML ADAS drive policy management system 400 may infer that the user has seen something or senses a condition that merits evaluation by the ADAS. In response, the ADAS may reconsider sensor data, focus one or more sensors in a particular direction, momentarily reduce speed, or take another action consistent with the inferred context of the occupant's utterance as determined by the AI/ML/

In block 908, the AI/ML ADAS drive policy management system 400 may implement the selected modified vehicle driving policy in response to the received driver acceptance indication, and control the vehicle accordingly as described for the like numbered block in the method 900.

FIG. 10B illustrates additional operations 1020 that may be performed as part of the method 1000 for managing driving policies in a vehicle ADAS using a detected vehicle context according to some embodiments. In block 1022, the AI/ML ADAS drive policy management system 400 may select one of a plurality of saved modified vehicle driving policies based on the inferred relevance of the user voice inputs. In block 1024, the AI/ML ADAS drive policy management system 400 may set the vehicle driving policy of the ADAS to the selected one of the pluralities of saved vehicle driving policies.

FIG. 10C illustrates additional operations 1040 that may be performed as part of the method 1000 for managing driving policies in a vehicle ADAS using a detected vehicle context according to some embodiments. In block 1042, the AI/ML ADAS drive policy management system 400 may recognize, based on the inferred relevance of the user voice input, that the user has provided a hint related to driving behaviors of the vehicle. In block 1044, the AI/ML ADAS drive policy management system 400 may modify the vehicle driving policy of the ADAS in response to recognizing that the user has provided a hint related to driving behaviors of the vehicle.

FIG. 10D illustrates additional operations 1060 that may be performed as part of the method 1000 for managing driving policies in a vehicle ADAS using a detected vehicle context according to some embodiments. In block 1062, the AI/ML ADAS drive policy management system 400 may recognize, based on the inferred relevance of the user voice input, that the user has provided a hint related to a condition external to the vehicle. In block 1064, the AI/ML ADAS drive policy management system 400 may reevaluate sensor data received from vehicle external sensors used by the ADAS in making driving decisions in response to recognizing that the user has provided a hint related to a condition external to the vehicle.

FIG. 10E illustrates additional operations 1080 that may be performed as part of the method 1000 for managing driving policies in a vehicle ADAS using a detected vehicle context according to some embodiments. In block 1082, the AI/ML ADAS drive policy management system 400 may recognize, based on the inferred relevance of the user voice input, that the user has issued a command related to a driving behavior of the vehicle. In block 1084, The AI/ML ADAS drive policy management system 400 may implement the user's command in response to the recognition that the user has issued a command related to a driving behavior of the vehicle. As described, implementation of the user command may be subject to the ADAS confirming that execution of the command is safe and/or feasible.

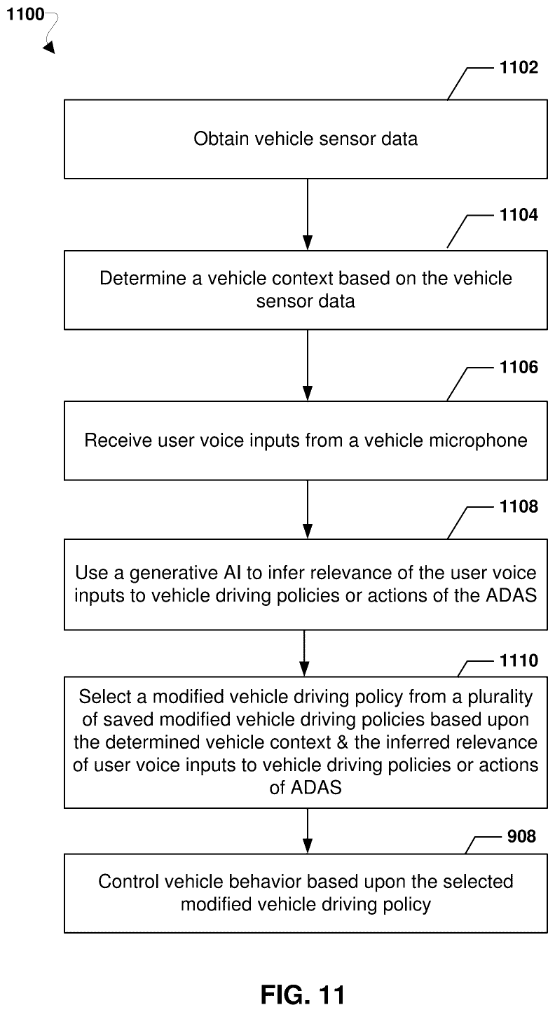

FIG. 11 is a process flow diagram illustrating a method 1100 of an AI/ML ADAS drive policy management system for managing driving policies in a vehicle ADAS based on vehicle context and user voice inputs according to some embodiments. With reference to FIGS. 1-11, the operations of the method 1100 may be performed by a processing system (e.g., 140, 312, 346, 500, 552) including one or more processors (e.g., 164, 314, 348, 503, 504, 506, 508, 510) and/or hardware elements, an AI/ML model (e.g., 560), any one or combination of which may be configured to perform any of the operations of the method 1100. Further, one or more processors within the processing system may be configured with software or firmware to perform various operations of the method. To encompass any of the processor(s), AI/ML module(s), hardware elements and software elements that may be involved in performing the method 1100, the elements performing method operations are referred to as a “processing system.” Further, means for performing functions of the method 1100 may include the processing system (e.g., 140, 312, 346, 500, 552) including one or more processors (e.g., 164, 314, 348, 503, 504, 506, 508, 510), and memory (e.g., (166, 318, 342, 512, 534).

In block 1102 the AI/ML ADAS drive policy management system 400 may obtain vehicle sensor data. As described, the vehicle may include a large number of internal and external sensors configured to provide information regarding conditions, situations, occupant information, etc. that are relevant to selecting and/or adjusting ADAS driving behaviors. The operations in block 1102 may be similar to those in block 902 as described.

In block 1104, the AI/ML ADAS drive policy management system 400 may determine a vehicle context based on the vehicle sensor data in. As described, the vehicle may include a large number of internal and external sensors configured to provide information that the AI/ML system may be trained to process as input and output one or more inferences that reflect conditions inside and outside the vehicle, including inferences regarding the driver/operator (e.g., identity, physical condition, attention, etc.) and other occupants in the vehicle. As described, using such sensor information to infer “context” includes identifying one or more conditions, situations, occupant information, etc. that are relevant to selecting and/or adjusting ADAS driving behaviors. The operations in block 1104 may be similar to those in block 904 as described.

In block 1106, the AI/ML ADAS drive policy management system 400 may receive user voice inputs from a vehicle microphone. The AI/ML ADAS drive policy management system 400 may use a generative AI (e.g., an LLM) to convert the user's voice inputs into text. In block 1108, the AI/ML ADAS drive policy management system 400 may infer relevance of the user voice inputs to vehicle driving policies or actions of the ADAS. The operations in blocks 1106 and 1108 may be similar to those in blocks 1002 and 1004 as described.

In block 1110, the AI/ML ADAS drive policy management system 400 may select a modified vehicle driving policy from a plurality of saved modified vehicle driving policies based on the determined vehicle context and the inferred relevance of the user voice inputs to vehicle driving policies or actions of the ADAS. Thus, in block 1110, the AI/ML ADAS drive policy management system 400 may take into consideration both the context of the vehicle and what the user says in selecting a modified ADAS driving policy.

In block 908, the AI/ML ADAS drive policy management system 400 may implement the selected modified vehicle driving policy in response to the received driver acceptance indication, and control the vehicle accordingly as described for the like numbered block in the method 900.

Implementation examples are described in the following paragraphs. While some of the following implementation examples are described in terms of example systems and methods, further example implementations may include: the example operations discussed in the following paragraphs may be implemented by various computing devices; the example methods discussed in the following paragraphs implemented by a vehicle including a processing system including one or more processors configured with processor-executable instructions to perform operations of the methods of the following implementation examples; the example methods discussed in the following paragraphs implemented by a vehicle including means for performing functions of the methods of the following implementation examples; and the example methods discussed in the following paragraphs may be implemented as a non-transitory processor-readable storage medium having stored thereon processor-executable instructions configured to cause a processing system of a vehicle to perform the operations of the methods of the following implementation examples.

Example 1. A method of managing driving policies in a vehicle ADAS, the method including: obtaining vehicle sensor data; determining a current vehicle context based on the vehicle sensor data; selecting a modified vehicle driving policy from a plurality of saved modified vehicle driving policies based on the determined current vehicle context; and controlling vehicle behavior by the ADAS based upon the selected modified vehicle driving policy.

Example 2. The method of example 1, further including: receiving a requested modification of the vehicle driving policy from a user; generating a new modified vehicle driving policy based on the user requested modification of the vehicle driving policy and the determined current vehicle context; and saving the new modified vehicle driving policy correlated to the determined current vehicle context as one of the plurality of saved modified vehicle driving policies.

Example 3. The method of example 2, in which generating a modified vehicle driving policy from the plurality of saved vehicle policies comprises: determining whether the determined vehicle context matches a vehicle context correlated to one of the plurality of saved modified vehicle driving policies; querying the driver regarding implementing a modified vehicle driving policy in response to the determined vehicle context matching a vehicle context correlated to one of the plurality of saved modified vehicle driving policies; receiving a driver indication accepting implementation of the saved modified vehicle driving policy correlated to the matched vehicle context; and selecting the modified vehicle driving policy correlated to the determined vehicle context in response to receiving the driver indication accepting implementation of the saved modified vehicle driving policy.

Example 4. The method of any of examples 1-4, in which controlling vehicle behavior by the ADAS based upon the selected modified vehicle driving policy comprises modifying one or more of a steering, braking, or acceleration policy of the vehicle ADAS.

Example 5. The method of any of examples 1-4, in which the plurality of modified vehicle driving policies comprises a set of modified vehicle driving policies correlated to a set of vehicle contexts that are preconfigured by an operator of a fleet of vehicles.

Example 6. The method of any of examples 1-5, in which: the plurality of modified vehicle driving policies comprises a plurality of driving modes correlated to a set of vehicle contexts; and controlling vehicle behavior by the ADAS based upon the selected modified vehicle driving policy comprises implementing one of the plurality of driving modes that is correlated to the determined vehicle context.

Example 7. A method of enabling a user to influence vehicle driving policy decisions of a vehicle ADAS based on user voice inputs, the method including: receiving user voice inputs from a vehicle microphone; using a generative AI to infer relevance of the user voice inputs to vehicle driving policies or actions of the ADAS; adjusting a vehicle driving policy of the ADAS based on the inferred relevance of the user voice inputs; and commanding vehicle behavior based upon the adjusted vehicle driving policy.

Example 8. The method of example 7, further including: selecting one of a plurality of saved modified vehicle driving policies based on the inferred relevance of the user voice inputs; and setting the vehicle driving policy of the ADAS to the selected one of the plurality of saved vehicle driving policies.

Example 9. The method of either of examples 7 or 8, further including: recognizing based on the inferred relevance of the user voice input that the user has provided a hint related to driving behaviors of the vehicle; and modifying the vehicle driving policy of the ADAS in response to recognizing that the user has provided a hint related to driving behaviors of the vehicle.

Example 10. The method of any of examples 7-9, further including: recognizing based on the inferred relevance of the user voice input that the user has provided a hint related to a condition external to the vehicle; and reevaluating data of vehicle external sensors used by the ADAS in making driving decisions in response to recognizing that the user has provided a hint related to a condition external to the vehicle.

Example 11. The method of any of examples 7-10, further including: recognizing based on the inferred relevance of the user voice input that the user has issued a command related to a driving behavior of the vehicle; and implementing the user's command in response to the recognized that the user has issued a command related to driving behavior of the vehicle.

Example 12. A method of managing driving policies in a vehicle ADAS based on vehicle context and user voice inputs, the method including: obtaining vehicle sensor data; determining a vehicle context based on the vehicle sensor data; receiving user voice inputs from a vehicle microphone; using a generative AI to infer relevance of the user voice inputs to vehicle driving policies or actions of the ADAS; selecting a modified vehicle driving policy from a plurality of saved modified vehicle driving policies based upon the determined vehicle context and the inferred relevance of the user voice inputs to vehicle driving policies or actions of the ADAS; and controlling vehicle behavior based upon the selected modified vehicle driving policy.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of enabling a user to influence vehicle driving policy decisions of a vehicle Advanced Driver Assist System (ADAS) based on user voice inputs, the method comprising:
receiving user voice inputs from a vehicle microphone;
using a generative AI to infer relevance of the user voice inputs to vehicle driving policies or actions of the ADAS;
adjusting a vehicle driving policy of the ADAS based on the inferred relevance of the user voice inputs; and
commanding vehicle behavior based on the adjusted vehicle driving policy.

2. The method of claim 1, further comprising:
selecting one of a plurality of saved modified vehicle driving policies based on the inferred relevance of the user voice inputs; and
setting the vehicle driving policy of the ADAS to the selected one of the plurality of saved vehicle driving policies.

3. The method of claim 1, further comprising:
recognizing based on the inferred relevance of the user voice input that the user has provided a hint related to driving behaviors of the vehicle; and
modifying the vehicle driving policy of the ADAS in response to recognizing that the user has provided a hint related to driving behaviors of the vehicle.

4. The method of claim 1, further comprising:
recognizing based on the inferred relevance of the user voice input that the user has provided a hint related to a condition external to the vehicle; and
reevaluating data of vehicle external sensors used by the ADAS in making driving decisions in response to recognizing that the user has provided a hint related to a condition external to the vehicle.

5. The method of claim 1, further comprising:
recognizing based on the inferred relevance of the user voice input that the user has issued a command related to a driving behavior of the vehicle; and
implementing the user's command in response to recognizing that the user has issued a command related to the driving behavior of the vehicle.

6. The method of claim 1, further comprising:
obtaining vehicle sensor data;
determining a vehicle context based on the vehicle sensor data; and
adjusting the vehicle driving policy of the ADAS based on the inferred relevance of the user voice inputs and the determined vehicle context.

7. A vehicle, comprising:
a memory; and
a processing system coupled to the memory, wherein the processing system includes an artificial intelligence/machine learning module and at least one processor configured to:
receive user voice inputs from a vehicle microphone;
use a generative AI to infer relevance of the user voice inputs to vehicle driving policies or actions of an Advanced Driver Assist System (ADAS);
adjust a vehicle driving policy of the ADAS based on the inferred relevance of the user voice inputs; and
command vehicle behavior based on the adjusted vehicle driving policy.

8. The vehicle of claim 7, wherein the artificial intelligence/machine learning module and at least one processor are further configured to:
select one of a plurality of saved modified vehicle driving policies based on the inferred relevance of the user voice inputs; and
set the vehicle driving policy of the ADAS to the selected one of the plurality of saved vehicle driving policies.

9. The vehicle of claim 7, wherein the artificial intelligence/machine learning module and at least one processor are further configured to:
recognize based on the inferred relevance of the user voice input that the user voice input provided a hint related to driving behaviors of the vehicle; and
modify the vehicle driving policy of the ADAS in response to recognizing that the user voice input provided a hint related to driving behaviors of the vehicle.

10. The vehicle of claim 7, wherein the artificial intelligence/machine learning module and at least one processor are further configured to:
recognize based on the inferred relevance of the user voice input that the user voice input provided a hint related to a condition external to the vehicle; and
reevaluate data of vehicle external sensors used by the ADAS in making driving decisions in response to recognizing that the user voice input provided a hint related to a condition external to the vehicle.

11. The vehicle of claim 7, wherein the artificial intelligence/machine learning module and at least one processor are further configured to:
recognize based on the inferred relevance of the user voice input that the user voice input included a command related to a driving behavior of the vehicle; and
implement the user's command in response to recognizing that the user voice input included a command related to the driving behavior of the vehicle.

12. The vehicle of claim 7, wherein the artificial intelligence/machine learning module and at least one processor are further configured to:
obtain vehicle sensor data;
determine a vehicle context based on the vehicle sensor data; and
adjust the vehicle driving policy of the ADAS based on the inferred relevance of the user voice inputs and the determined vehicle context.

13. A non-transitory processor-readable medium having stored thereon processor-executable instructions configured to cause a processor of a vehicle processing system to perform operations comprising:
receiving user voice inputs from a vehicle microphone;
using a generative AI to infer relevance of the user voice inputs to vehicle driving policies or actions of an Advanced Driver Assist System (ADAS);
adjusting a vehicle driving policy of the ADAS based on the inferred relevance of the user voice inputs; and
commanding vehicle behavior based on the adjusted vehicle driving policy.

14. The non-transitory processor-readable medium of claim 13, wherein the stored processor-executable instructions are configured to cause a processor of a vehicle processing system to perform operations further comprising:
selecting one of a plurality of saved modified vehicle driving policies based on the inferred relevance of the user voice inputs; and
setting the vehicle driving policy of the ADAS to the selected one of the plurality of saved vehicle driving policies.

15. The non-transitory processor-readable medium of claim 13, wherein the stored processor-executable instructions are configured to cause a processor of a vehicle processing system to perform operations further comprising:
recognizing based on the inferred relevance of the user voice input that the user voice input provided a hint related to driving behaviors of the vehicle; and
modifying the vehicle driving policy of the ADAS in response to recognizing that the user voice input provided a hint related to driving behaviors of the vehicle.

16. The non-transitory processor-readable medium of claim 13, wherein the stored processor-executable instructions are configured to cause a processor of a vehicle processing system to perform operations further comprising:
recognizing based on the inferred relevance of the user voice input that the user voice input provided a hint related to a condition external to the vehicle; and
reevaluating data of vehicle external sensors used by the ADAS in making driving decisions in response to recognizing that the user voice input provided a hint related to a condition external to the vehicle.

17. The non-transitory processor-readable medium of claim 13, wherein the stored processor-executable instructions are configured to cause a processor of a vehicle processing system to perform operations further comprising:
recognizing based on the inferred relevance of the user voice input that the user voice input included a command related to a driving behavior of the vehicle; and
implementing the command in response to recognizing that the user voice input included a command related to the driving behavior of the vehicle.

18. The non-transitory processor-readable medium of claim 13, wherein the stored processor-executable instructions are configured to cause a processor of a vehicle processing system to perform operations further comprising:
obtaining vehicle sensor data;
determining a vehicle context based on the vehicle sensor data; and
adjusting the vehicle driving policy of the ADAS based on the inferred relevance of the user voice inputs.
